(19) United States
(12) Patent Application Publication
(10) Pub. No.: US 2002/0128768 A1
(43) Pub. Date: Sep. 12, 2002

(54) Route guide information distributing system

(76) Inventors: Nobuyuki Nakano, Toyonaka (JP); Ryotaro Iwami, Kobe (JP); Akihiro Suzuki, Neyagawa (JP); Yutaka Watanabe, Neyagawa (JP)

Correspondence Address: WENDEROTH, LIND & PONACK, L.L.P., 2033 K STREET N. W., SUITE 800, WASHINGTON, DC, 20006-1021, US

(21) Appl. No.: 10/091,421

(22) Filed: Mar. 7, 2002

(30) Foreign Application Priority Data
Mar. 9, 2001 (JP) 2001-067529

(51) Int. Cl. G01C 21/34

(52) U.S. Cl. 701/202; 701/209; 340/995

(57) ABSTRACT

A terminal 1 transmits a route guide information request message that specifies the starting point and the destination point to a center station 2. The center station 2 searches for a route based on the received message, and transmits route guide information including a recommended route. On the recommended route, points where the direction of travel is changed more than a predetermined angle or points where the name of the road is changed are set as guide points. The route guide information includes data varying in degree of details depending on areas surrounding the guide points or the other areas. For each area surrounding the guide point, the route guide information includes the direction of travel at that guide point, detailed information about road shapes, road network data including not only the recommended road but also the other roads, etc. For each of the other areas, minimum guide information required is included in the route guide information. Thus, the route guide information can be reduced in amount while being kept in usefulness.

### BACKGROUND OF THE INVENTION

1. Field of the Invention

The present invention relates to route guide information distributing system constructed by a plurality of vehicle-mounted information terminals and an information center for distributing route guide information to the vehicle-mounted information terminals.

2. Description of the Background Art

In recent years, many vehicles have a navigation system mounted thereon. In conventional navigation systems, map data is previously recorded in a recording medium such as CD-ROM or DVD-ROM, and is read into main memory as required for use in processes such as map display, calculation of the current position of the vehicle (map matching), and route search for finding a recommended route between arbitrary points. As such, the conventional navigation system requires a recording medium for storing a large amount of map data, and a disk drive for reading the data from the recording medium, thereby causing difficulty in reducing price, size, and weight of components in the navigation system. Also, opening of a new road or closing of the existing road causes a discrepancy between the map data previously stored in the recording medium and the actual state of roads, thereby causing some trouble in map display, current position detection, and route search.

To solve the above problems, interactive route guide systems without map data stored in the navigation system side have been suggested. In these systems, route information is distributed to the vehicle-mounted device from the information center place data predetermined location. Using the distributed route information, the vehicle-mounted device guides a driver to the destination. By way of example, Japanese Patent Laid-Open Publication No. 11-295096 (1999-295096) discloses a route data transmitting device for distributing road network data of a recommended route to the destination and also road network data of a recovery route to be taken for getting the vehicle back to the recommended route. According to the system disclosed therein, even if the vehicle goes out of the recommended route, the vehicle-mounted terminal keeps guiding the vehicle for getting it back to the recommended route by using data of the recovery route.

In the interactive route guide systems, however, only the route information distributed from the information center to the vehicle-mounted terminal is used to detect the current position of the vehicle and guide it to the destination. Therefore, the distributed route information has to include sufficient data for making the process appropriate. The longer the distance between the starting point to the destination, the larger the amount of the route information becomes. Distributing a large amount of route information from the information center to the vehicle-mounted terminal requires a large amount of communications time and cost. To avoid this drawback of increasing communications cost, if the amount of data included in the route information is reduced, the vehicle-mounted device cannot appropriately carry out current position detection and route guidance.

By way of example, if the route guide system disclosed in the above Japanese Patent Laid-Open Publication No. 11-295096 is used for finding a recommended route from a starting point SP to a destination point DP and recovery routes, such results as shown in FIG. 30 are obtained. In this system, data indicating route link strings has to be distributed from the information center to the vehicle-mounted terminal. The route link strings connecting the starting point SP to the destination DP include a large number of nodes N each representing an intersection (hollow circles in FIG. 31), and a large number of shape points S where the shape of the road is changed (hatched circles in FIG. 31). Therefore, the longer the route from the starting point SP to the destination DP, the larger the amount of data of the recommended route and the recovery routes. Also, if a route far away from the recommended route is selected as the recovery route, the amount of data becomes further increased. For this reason, in the interactive route guide system, the contents and structure of the route information are important matters to be considered for reducing the amount of data while keeping the usefulness of the route information.

In one known method used for the interactive route guide systems, information about a path traveled by the vehicle is transmitted from the vehicle-mounted terminal to the information center for use in updating the map data stored therein. However, most users would not agree to transmit such traveled path information because their privacy may be violated. Therefore, the information center cannot collect sufficient traveled path information. Thus, this method is not so effective as anticipated.

### SUMMARY OF THE INVENTION

Therefore, a first object of the present invention is to provide a route guide information distributing system capable of current position detection, recommended route guidance, and recovery route guidance by using route information reduced in data amount, thereby reducing time and cost required for distributing the route information. A second object of the present invention is to provide a route guide information distributing system enabling an information center to sufficiently collect information about a path traveled by a vehicle.

The present invention has the following features to attain the objects above.

A first aspect of the present invention is directed to a route guide information distributing apparatus for distributing route guide information to a terminal, and the apparatus includes: a communications unit for transmitting and receiving data from and to the terminal; a map data storage unit for storing map data; a route searching unit for searching, by using the map data stored in the map data storage unit, for a recommended route between arbitrary points requested by the terminal; a guide point setting unit for setting a guide point on the recommended route found by the route searching unit; and a route guide information generating unit for generating the route guide information related to the recommended route for distribution to the terminal based on the map data stored in the map data storage unit, the route guide information including data varying in degree of details depending on a distance from the guide point.

According to the first aspect, the guide point is set on the found recommended route. Furthermore, the route guide information distributed from the route guide information distributing apparatus to the terminal includes data varying in degree of details depending on the distance from the guide point. The data of an area surrounding the guide point is detailed, while the data of the other areas includes only minimum data required. Therefore, the route guide information can be reduced in amount while being kept in usefulness, thereby also reducing communications cost required for distribution of the route guide information.

In this case, the data included in the route guide information may be more detailed as the distance from the guide point is shorter. Preferably, the data of an area within a predetermined distance away from the guide point included in the guide information may have at least road names, road shapes, a direction of travel at the guide point, and a recovery route for getting a vehicle back to the recommended route, and the data of an area the predetermined distance or more away from the guide point may have at least road names and a direction of travel at the guide point.

Alternatively, the guide point setting unit may set the guide point on the recommended route at a point where a road name is changed or a point where a direction of travel is changed more than a predetermined angle. Thus, it is possible to set the guide point at a point where the driver is prone to select a wrong route.

Alternatively, the route guide information distributing apparatus may further include a guide program generating unit for generating a route guide program to be executed in route guidance carried out by using the route guide information, the program being distributed to the terminal. Thus, the terminal can carry out route guidance by using the route guide information and the program both distributed by the route guide information distributing apparatus.

Alternatively, the route guide information distributing apparatus may further include a map data updating unit for updating the map data stored in the map data storage unit based on traveled path information received from the terminal. More preferably, the map data updating unit may carry out a statistical process on the traveled path information for obtaining statistical data, and may update the map data stored in the map data storage unit based on the obtained statistical data. Still more preferably, the route searching unit may search for the recommended route between the arbitrary points by using the map data stored in the map data storage unit and the statistical data obtained by the map data updating unit.

Thus, the information about the path actually traveled by the vehicle is transmitted from the terminal to the route guide information distributing apparatus. Therefore, the route guide information distributing apparatus can reflect the latest states of travel by the vehicle onto the map data by using the received traveled path information. Also, the terminal can carry out route guidance by using the route guide information generated based on this latest map data. Furthermore, it is possible to reduce maintenance cost of the map data in the route guide information distributing apparatus and, accordingly, use cost of the route guide information in the terminal. When the route guide information distributing apparatus refers to statistical data to find a recommended route, it refers to the received traveled path information to update the map data and correct weights of cost applied for the route search process. After updating and correction, when requested to distribute the route guide information, the route guide information distributing apparatus can generate route guide information including a route suitable for user's preferences or a best possible route reflecting the actual states of roads. Moreover, by using such route guide information, the terminal can carry out route guidance, presenting the user-preferred or best-possible route.

Alternatively, the route guide information distributing apparatus may further include a billing managing unit for carrying out a billing process for distribution of the route guide information by applying different schemes to the terminal depending on whether the terminal allows transmission of the traveled path information or not. This encourages the terminals to transmit the traveled path information. Therefore, the route guide information distributing apparatus has a better chance to collect more traveled path information, thereby improving the accuracy of the map data. Consequently, more useful route guide information can be distributed to the terminal.

A second aspect of the present invention is directed to a route guide information distributing apparatus for distributing route guide information to a terminal, and the apparatus includes: a communications unit for transmitting and receiving data from and to the terminal;map data storage unit for storing map data; a route searching unit for searching, by using the map data stored in the map data storage unit, for a recommended route between arbitrary points requested by the terminal; a route guide information generating unit for generating the route guide information related to the recommended route for distribution to the terminal based on the map data stored in the map data storage unit; a map data updating unit for updating the map data stored in the map data storage unit based on traveled path information received from the terminal; and a billing managing unit for carrying out a billing process for distribution of the route guide information by applying different schemes to the terminal depending on whether the terminal allows transmission of the traveled path information or not.

According to the second aspect, the information about the path actually traveled by the vehicle is transmitted from the terminal to the route guide information distributing apparatus. Therefore, the route guide information distributing apparatus can reflect the latest states of travel by the vehicle onto the map data by using the received traveled path information. Also, the terminal can carry out route guidance by using the route guide information generated based on the latest map data. Furthermore, it is possible to reduce maintenance cost of the map data in the route guide information distributing apparatus and, accordingly, use cost of the route guide information in the terminal. In addition, the terminals are encouraged to transmit the traveled path information. Therefore, the route guide information distributing apparatus has a better chance to collect more traveled path information, thereby improving the accuracy of the map data. Consequently, more useful route guide information can be distributed to the terminal.

In this case, the map data updating unit may carry out a statistical process on the traveled path information for obtaining statistical data, and may update the map data stored in the map data storage unit based on the obtained statistical data. More preferably, the route searching unit may search for the recommended route between the arbitrary points by using the map data stored in the map data storage unit and the statistical data obtained by the map data updating unit.

Thus, the route guide information distributing apparatus can statistically process the received route guide information to update the map data. When the route guide information distributing apparatus refers to statistical data to find a recommended route, it refers to the received traveled path information to update the map data and correct weights of cost applied for the route search process. After updating and correction, when requested to distribute the route guide information, the route guide information distributing apparatus can generate route guide information including a route suitable for user's preferences or a best possible route reflecting the actual states. Moreover, by using such route guide information, the terminal can carry out route guidance, presenting the user-preferred or best-possible route.

A third aspect of the present invention is directed to a route guide information receiving apparatus for carrying out route guidance by using route guide information distributed by a server, and the route guide information receiving apparatus includes: a position detecting unit for detecting a current position of the apparatus by using a sensor; a communications means for transmitting and receiving data from and to the terminal; a route guide information receiving unit for requesting the server to distribute the route guide information related to a recommended route between arbitrary points, the route guide information including data varying in degree of details depending on a distance from a guide point set on the recommended route; and a route guiding unit for carrying out the route guidance by using the route guide information received by the route guide information receiving unit and the current position detected by the position detecting unit.

According to the third aspect, the guide point is set on the found recommended route. Furthermore, the route guide information distributed from the server to the route guide information receiving apparatus includes data varying in degree of details depending on the distance from the guide point. The data of an area surrounding the guide point is detailed, while the data of the other areas includes only minimum data required. Therefore, the route guide information can be reduced in amount while being kept in usefulness, thereby also reducing communications cost required for distribution of the route guide information

In this case, the data included in the route guide information may be more detailed as the distance from the guide point is shorter. More preferably, the data of an area within a predetermined distance away from the guide point included in the guide information may have at least road names, road shapes, a direction of travel at the guide point, and a recovery route for getting a vehicle back to the recommended route, and the data of an area the predetermined distance or more away from the guide point may have at least road names and a direction of travel at the guide point.

Alternatively, the guide point may be set on the recommended route at a point where the road name is changed or a point where a direction of travel is changed more than a predetermined angle. Thus, it is possible to set the guide point at a point where the driver is prone to select a wrong route.

Alternatively, the route guiding unit may carry out the route guidance by following a route guide program distributed by the server. Thus, the route guide information receiving apparatus can carry out route guidance using the route guide information and the program both distributed from the server.

Alternatively, the route guide information receiving apparatus may further include a traveled path information generating unit for generating traveled path information based on the current position detected by the position detecting unit. More preferably, the route guide information receiving apparatus may further include a transmission switching unit for switching whether or not to transmit the traveled path information to the server depending on a selection by a user.

Thus, the information about the path actually traveled by the vehicle is transmitted from the route guide information receiving apparatus to the server. Therefore, the server can reflect the latest states of travel by the vehicle onto the map data by using the received traveled path information. Also, the route guide information receiving apparatus can carry out route guidance by using the route guide information generated based on the latest map data updated in the above manner. Furthermore, maintenance cost of the map data in the server can be reduced. Accordingly, use cost of the route guide information in the route guide information receiving apparatus can be reduced. When the route guide information includes a transmission switching unit, the user can select whether to transmit the information about the path actually traveled by the vehicle or not, thereby protecting his/her privacy.

A fourth aspect of the present invention is directed to a route guide information receiving apparatus for carrying out route guidance by using route guide information distributed from a server, and the route guide information receiving apparatus includes: a position detecting unit for detecting a current position of the apparatus by using a sensor; communications unit for transmitting and receiving data to and from the server; a route guide information receiving unit for requesting the server to distribute the route guide information related to a recommended route between arbitrary points; a route guiding unit for carrying out the route guidance by using the route guide information received by the route guide information receiving unit and the current position detected by the position detecting unit; a traveled path information generating unit for generating traveled path information for transmission to the server based on the current position detected by the position detection unit; and a transmission switching unit for switching whether or not to transmit the traveled path information to the server depending on a selection by a user.

According to the fourth aspect, the information about the path actually traveled by the vehicle is transmitted from the route guide information receiving apparatus to the server. Therefore, the server can reflect the latest states of travel by the vehicle onto the map data by using the received traveled path information. Also, the route guide information receiving apparatus can carry out route guidance by using the route guide information updated in the above manner. Furthermore, it is possible to reduce maintenance cost of the map data in the server and, accordingly, use cost of the route guide information in the route guide information receiving apparatus. In addition, by selecting whether or not to transmit the information about the path actually traveled by the vehicle, the user can protect his/her privacy.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram illustrating the configuration of a route guide information distributing system according to a first embodiment of the present invention;

FIG. 2 is an illustration showing the data structure of a route guide information request message in the route guide information distributing system according to the first embodiment of the present invention;

FIG. 3 is an illustration showing the data structure of route guide information in the route guide information distributing system according to the first embodiment of the present invention;

FIG. 4 is an illustration for demonstrating a connection angle between an incoming route and an outgoing route at an intersection;

FIG. 5 is an illustration for demonstrating a recommended route, guide points, and detailed route areas;

FIG. 6 is a flowchart showing the main processing in a terminal 1 according to the first embodiment of the present invention;

FIG. 7 is a flowchart showing a route guide information receiving process in the terminal 1 according to the first embodiment of the present invention;

FIG. 8 is a flowchart showing a guide process in the terminal 1 according to the first embodiment of the present invention;

FIGS. 9A to 9D are illustrations each showing an example display screen in the terminal 1 according to the first embodiment of the present invention;

FIG. 10 is a flowchart showing a route recovery process in the terminal 1 according to the first embodiment of the present invention;

FIG. 11 is a flowchart showing a position detecting process at the terminal 1 according to the first embodiment of the present invention;

FIG. 12 is a flowchart showing a process at a center station 2 according to the first embodiment of the present invention;

FIG. 13 is an illustration showing example road network data at the center station 2 according to the first embodiment of the present invention;

FIG. 14 is an illustration showing an example recommended route from a starting point to a destination on the road network data shown in FIG. 13;

FIG. 15 is an illustration showing an example result after guide points are set on the recommended route shown in FIG. 14;

FIG. 16 is an illustration showing an example result after detailed route areas are set in the vicinity of the guide points shown in FIG. 15;

FIG. 17 is an illustration showing an example result after recovery routes are selected in the detailed route areas shown in FIG. 16;

FIG. 18 is an illustration showing a result after the road network data is selected from the detailed route areas shown in FIG. 16;

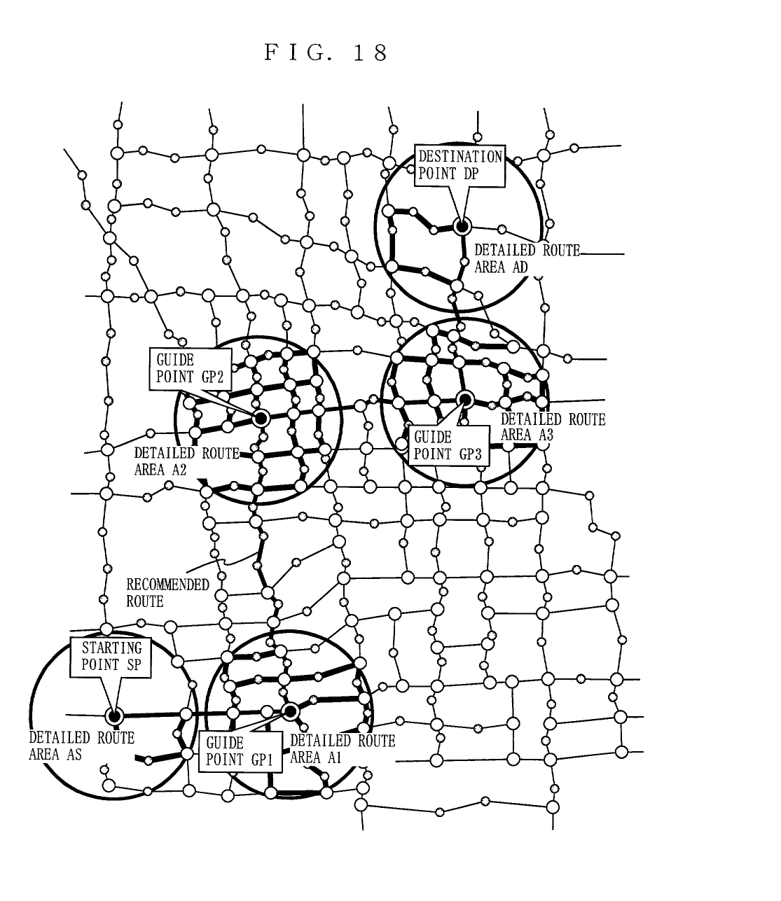

FIG. 19 is an illustration showing the data structure of traveled path information in a route guide information distributing system according to a second embodiment of the present invention;

FIG. 20 is a flowchart showing the main processing in the terminal 1 according to the second embodiment of the present invention;

FIG. 21 is a flowchart showing a position detecting process in the terminal 1 according to the second embodiment of the present invention;

FIG. 22 is a flowchart showing the main processing in the center station 2 according to the second embodiment of the present invention;

FIG. 23 is an illustration showing the data structure of a link-to-path list at the center station 2 according to the second embodiment of the present invention;

FIG. 24 is a block diagram showing the configuration of a route guide information distributing system according to a third embodiment of the present invention;

FIG. 25 is a flowchart showing the main processing in a center station 4 according to the third embodiment of the present invention;

FIG. 26 is an example of a billing management table 26 stored in the center station 4 according to the third embodiment of the present invention;

FIG. 27 is a flowchart showing a fee calculating process in the center station 4 according to the third embodiment of the present invention;

FIG. 28 is a flowchart showing the main processing in the center station 4 according to an example modification of the third embodiment of the present invention;

FIG. 29 is an example of the billing management table 26 stored in the center station 4 according to the example modification of the third embodiment of the present invention;

FIG. 30 is an illustration showing an example of a recommended route and a recovery route between a starting point and a destination point in road network data shown in FIG. 13; and

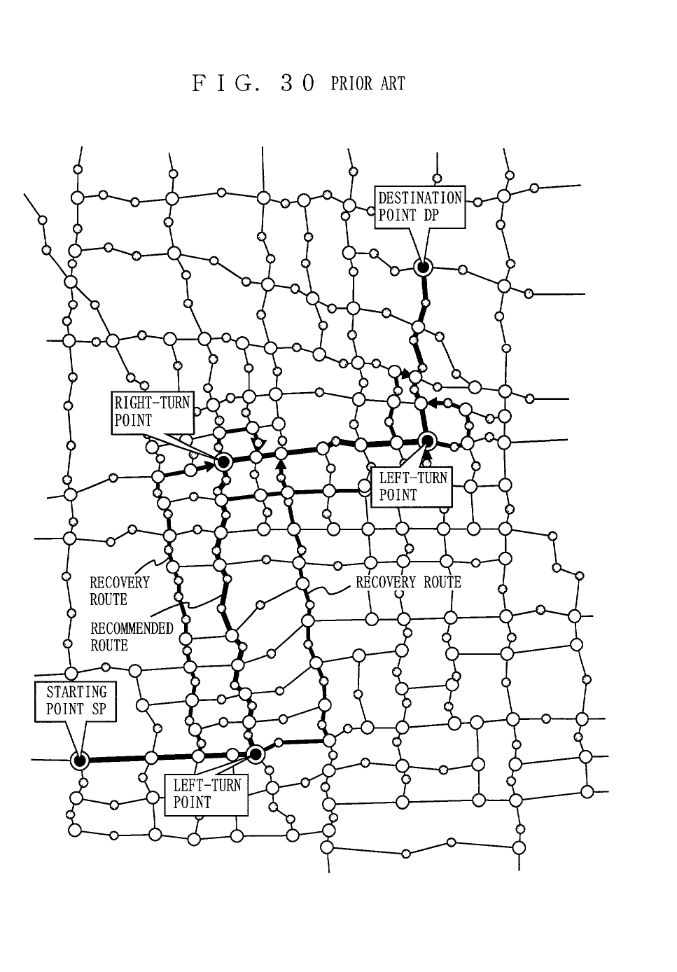

FIG. 31 is an illustration showing data included in route information in a conventional route guide system.

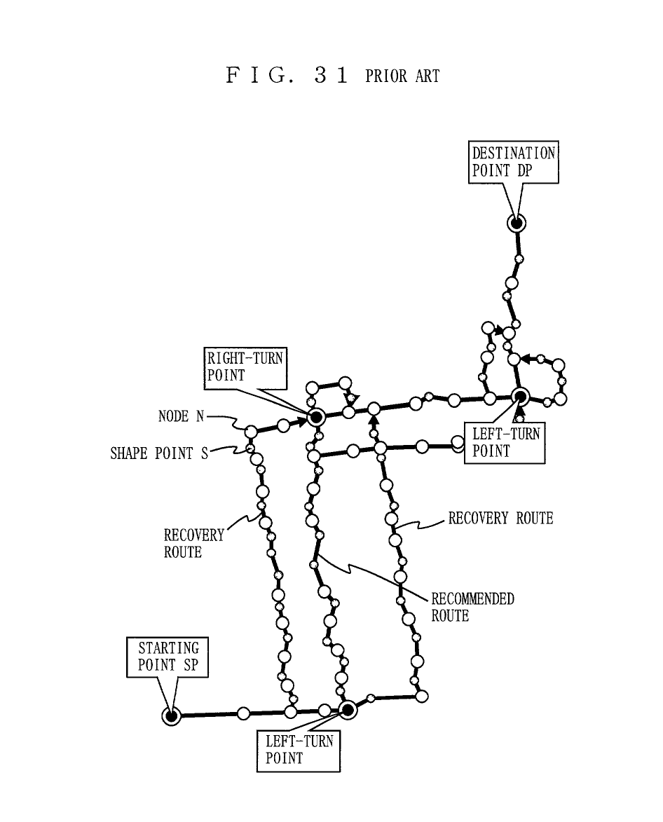

### DESCRIPTION OF THE PREFERRED EMBODIMENTS

### FIRST EMBODIMENT

### System Configuration

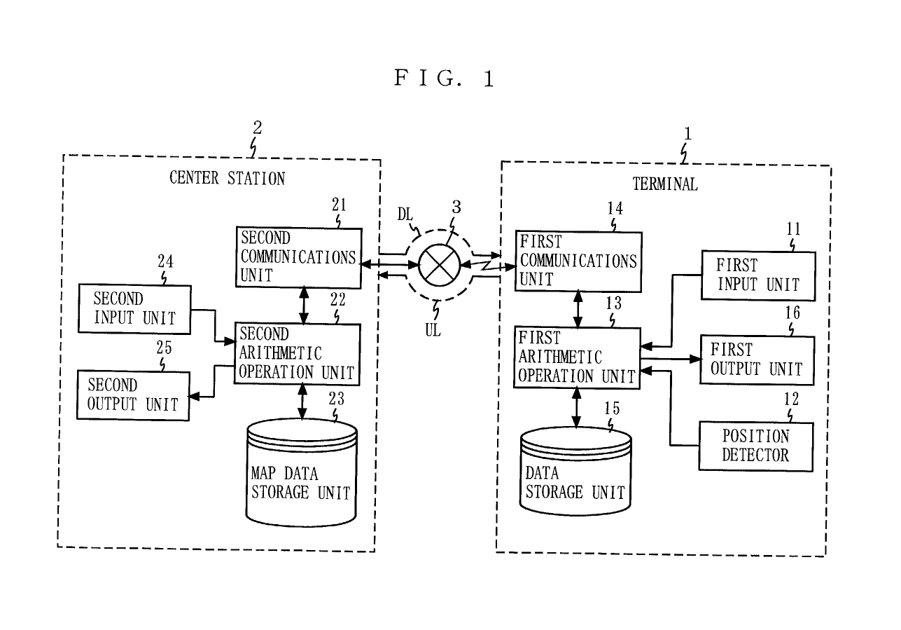

FIG. 1 is a block diagram illustrating the configuration of a route guide information distributing system according to a first embodiment of the present invention. The route guide information distributing system shown in FIG. 1 is configured by a plurality of terminals 1 (only one terminal 1 is shown for convenience) and a center station 2. The terminal 1 corresponds to a navigation system mounted on the vehicle for use. The center station 2 distributes route guide information to the plurality of terminals 1 located within its covering area.

The terminals 1 and the center station 2 are interactively connected to each other through a communications network 3. More specifically, located between the terminal 1 and the center station 2 are an uplink UL going from the terminal 1 to the center station 2 and a downlink DL going from the center station 2 to the terminals 1. The communications network 3 is structured by a communications network for mobile units such as cellular phones, a public circuit network such as ISDN (Integrated Services Digital Network), a dedicated circuit, or varying combinations thereof.

The terminal 1 may be directly connected to the center station 2 for access through the communications network 3. Alternatively, the terminal 1 may be connected via an access point to an Internet service provider (ISP) for indirect connection to the center station 2. In this case, communications between the terminal 1 and the ISP is carried out, in general, by complying with PPP (Point-to-Point Protocol). With PPP, the terminal 1 can transmit and receive data using a TCP/IP packet standardized for use over the Internet. PPP and TCP/IP are well known, and therefore not described herein.

The terminal 1 includes a first input unit 11, a position detector 12, a first arithmetic operation unit 13, a first communications unit 14, a data storage unit 15, and a first output unit 16.

The user of the terminal 1 uses the first input unit 11 to instruct the terminal 1 to carry out various operations such as selecting information to be displayed, searching for information, or connecting to the center station 2. The first input unit 11 may be implemented as hardware by keys provided on the terminal 1 or on a remote controller for remotely controlling the terminal 1, or as software by buttons on a menu screen displayed on the terminal 1. Also, the first input unit 11 may be implemented by a voice recognition system.

The position detector 12 detects the current position of the terminal 1 using various sensors incorporated therein, such as a speed sensor, a gyroscopic sensor, or a GPS (Global Positioning System) sensor composed of a GPS antenna and its receiver. If having a speed sensor, the position detector 12 detects the travel speed of the terminal 1 and, based on the detected speed, calculates the distance traveled. If having a gyroscopic sensor, the position detector 12 detects a direction to which the terminal 1 is traveling. If having a GPS sensor, the position detector 12 receives a radio wave from a satellite for detecting the absolute position of the terminal 1 on the earth. The position detector 12 may include all or some of the above sensors for detecting the position of the terminal 1 based on output values from these sensors. Alternatively, the position detector 12 may obtain the current position of the terminal 1 based on the output value(s) from the sensor(s), and then refer to road network data stored in the data storage unit 15 to carry out map matching for correcting the current position to be located on a road.

The first arithmetic operation unit 13 carries out various data processing typified by a guide process, which will be described later. In the guide process, the first arithmetic operation unit 13 uses the current position detected by the position detector 12 and the route guide information stored in the data storage unit 15 to make a screen for route guidance displayed on the first output unit 16.

The first communications unit 14 transmits to and receives from the center station 2 via the communications network 3. The first communications unit 14 is typically implemented by a mobile communications device such as a cellular phone. The first communications unit 14 sends a message for requesting route guide information to the uplink UL of the communications network 3, and receives the route guide information from the downlink DL of the communications network 3. The route guide request message and the route guide information will be described later in detail.

The data storage unit 15 is typically implemented by a rewritable recording medium such as a hard disk drive or flash memory. The data storage unit 15 stores the route guide information distributed from the center station 2.

The first output unit 16 is typically implemented by a display device and a loudspeaker. On the display device, a map with the current position indicated thereon and/or the route guide screen are displayed. The loudspeaker provides route guide information by voice.

The center station 2 includes a second communications unit 21, a second arithmetic operation unit 22, a map data storage unit 23, a second input unit 24, and a second output unit 25.

The second communications unit 21 transmits and receives data to and from the terminal 1 via the communications network 3. The second communications unit 21 is typically implemented by a communications device such as a modem, a terminal adaptor, or a gateway that can convert a communications protocol used over the communications network 3 into the one according to the specifications of the center station 2 and can also prevent unauthorized access to the center station 2. The second communications unit 21 receives the route guide information request message via the uplink UL of the communications network 3, and sends the route guide information to the downlink DL of the communications network 3.

The second arithmetic operation unit 22 carries out various data processing typified by a process for generating the route guide information based on the received route guide information request message and the map data stored in the map data storage unit 23, which will be described later in detail.

The map data storage unit 23 stores the map data on which the route guide information is based. The map data storage unit 23 is typically implemented by a hard disk drive, a CD-ROM drive, or a DVD-ROM drive, including at least a data-readable recording medium and a driver software therefor. The map data stored in the map data storage unit 23 is used for finding a recommended route between arbitrary points or generating route guide information using the found route. For this reason, the map data is stored in a vector format enabling easy recognition of road connections in the network.

The second input unit 24 is implemented by an input device, such as a key board or a mouse, for use in a computer system. The operator operates and manages the center station 2 by using the second input unit 24 to provide various instructions to the center station 2.

The second output unit 25 is typically implemented by a display device. Mainly displayed on the display device is an image based on the road network data stored in the map data storage unit 23.

The route guide information distributing system shown in FIG. 1 mainly operates as follows. The position detector 12 detects the current position of the terminal 1. The user of the terminal 1 uses the first input unit 11 to specify the destination and make a request for the route guide information. The first arithmetic operation unit 13 generates a route guide information request message including the current position and the destination. The route guide information request message goes through the first communications unit 14, the communications network 3, and the second communications unit 21 to reach the second arithmetic operation unit 22. The second arithmetic operation unit 22 generates the route guide information based on the received route guide information request message and the map data stored in the map data storage unit 23. The route guide information goes through the second communications unit 21, the communications network 3, and the first communications unit 14 to reach the first arithmetic operation unit 13. Based on the received route guide information, the first arithmetic operation unit 13 carries out such a process as making the route guide screen displayed on the first output unit 16.

(Details of the Route Guide Information Request Message and Route Guide Information)

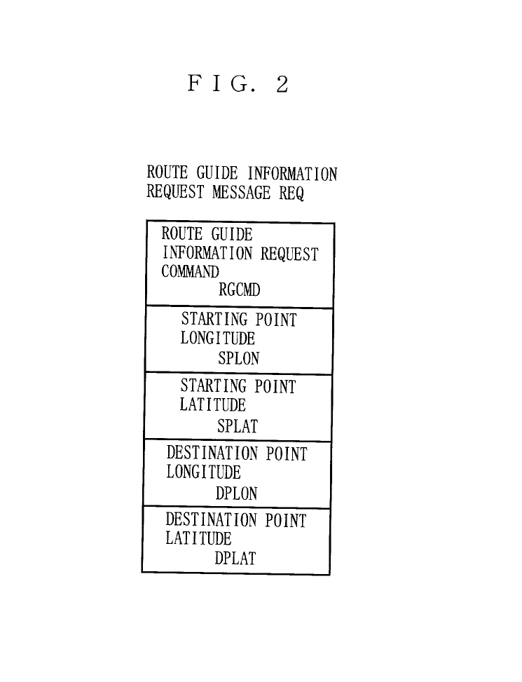

FIG. 2 is an illustration of the data structure of a route guide information request message REQ. The terminal 1 transmits to the center station 2 the route guide information request message including the starting point and the destination point, thereby requesting the center station 2 to distribute the route guide information. In FIG. 2, a route guide information request command RGCMD indicates that this message is a message for requesting the route guide information. This command is provided for specifying data to be distributed, since the terminal 1 also requests for distribution of various information other than the route guide information, such as POI-related (Point of Interest) information and traffic information. A starting point longitude SPLON and a starting point latitude SPLAT indicate a longitude and a latitude, respectively, of the starting point. A destination point longitude DPLON and a destination point latitude SPLAT indicate a longitude and a latitude, respectively, of the destination point.

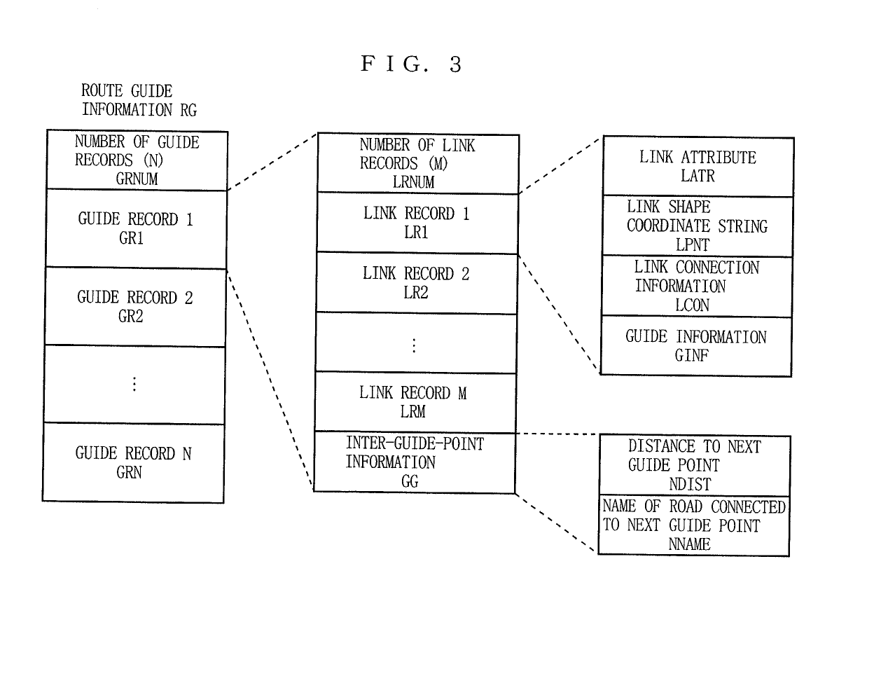

FIG. 3 is an illustration of the data structure of route guide information RG. The center station 2 generates the route guide information for distribution to the terminal 1 based on the received route guide information request message and the map data stored in the map data storage unit 23. Prior to details of FIG. 3, data included in the route guide information is described first.

The terminal 1 does not store the map data in advance, but uses only the route guide information for carrying out route guidance. Therefore, the route guide information has to include sufficient data for appropriately carrying out various processes, such as detecting of the current position of the vehicle, recommended route guidance, and guidance for getting the vehicle back to the recommended route. On the other hand, the driver does not necessarily use information about all intersections located on the recommended road. To drive the vehicle to the destination, the driver may use only the information about intersections where the name of the road is changed or where the direction of travel is changed. Therefore, hereinafter, a point required for route guide and located on a route from the starting point to the destination point is called “guide point”. As the guide point, for example, an intersection where the name of the road is changed or an intersection where the direction of travel is changed more than a predetermined angle. Alternatively, an intersection where drivers practically often make a mistake in deciding which way to go may be selected as the guide point. With the directions of travel at the respective guide points and the respective distances therebetween, the driver can travel the specified distance to reach each guide point, where he/she changes the direction of travel. By repeating this operation, the driver can reach the destination point in the end. Therefore, with at least the above two types of data (the directions of travel and the distances), the terminal 1 can carry out minimum-level guidance. In practice, however, the route guide information has to include other data in consideration of a case where the vehicle may go out of the recommended road.

The basics of route guidance is to present to the driver an appropriate road and direction of travel at appropriate timing. Therefore, the terminal 1 carries out route guidance by presenting to the driver the following four pieces of information:

(1) a road to travel;

(2) an intersection as the next guide point;

(3) a distance from the current position to the next guide point; and

(4) a direction of travel at the next guide point.

For the purpose of presenting the road to travel (refer to the above (1)), the route guide information includes names of roads between guide points. The road name is quite effective for the driver to relate the road he/she is actually driving to a route presented by route guidance. The center station 2 sets, without exception, points where the name of the road is changed on the route as guide points, and generates the route guide information including the road names. The terminal 1 receives the route guide information including the road names, and displays the name of the road to travel or producing it in synthesized voice until the vehicle reaches the next guide point.

To present the intersection as the next guide point (refer to the above (2)), the route guide information includes the name of the intersection, or the name of a road branching at that intersection. That is, if the guide point is an intersection provided with a name, the center station 2 generates route guide information including the name of the intersection as information for specifying the guide point. In this case, when guiding the vehicle before coming to the guide point, the terminal 1 presents such guide information as “Turn right at X intersection”. On the other hand, if the guide point is an intersection without a name, the center station 2 generates route guide information including the name of the road branching at that intersection as the information for specifying the guide point. In this case, when guiding the vehicle before coming to the guide point, the terminal 1 presents such guide information as “Drive X street and then turn right”.

In strict terms, to present the distance from the current position to the next guide point (refer to the above (3)), route information including information about the exact shape of the road between the guide points has to be used for calculating the distance to the next guide point along the shape of the road. In this method, however, if the recommended road from the starting point to the destination point is long, an enormous amount of route guide information is required. Therefore, in this embodiment, assume that the accurate distance is presented when the vehicle comes to a point several kilometers before the guide point, and only an approximate distance is presented when otherwise. Therefore, the center station 2 generates route guide information including detailed road network data within a several-kilometer radius of each guide point but not including such data outside the radius.

In one method according to the present embodiment, it may be difficult to accurately find the current position of the vehicle on the route until reaching a point several kilometers before the guide point. However, in this method, intersections where the driver are prone to make a mistake in selecting the route are set as the guide points. With such intersections, the present method poses no problem to the driver for traveling even though he/she does not exactly know the current position of the vehicle on a relatively long section between the guide points. By watching a screen displayed during route guidance indicating the name of the road, the driver can compare the name of the road he/she is actually driving with that displayed on the screen to see whether the road he/she is driving is on the recommended route. Also, by calculating a linear distance between the current position obtained by the GPS sensor and the next guide point, the terminal 1 can present to the driver an approximate distance to the next guide point.

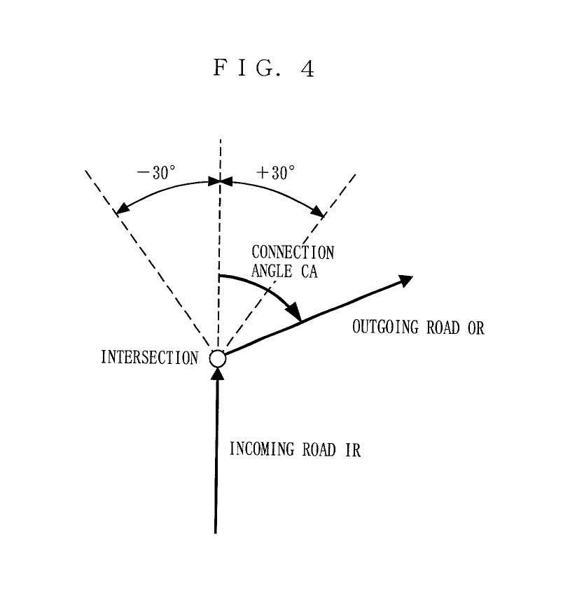

To present the direction of travel at the next guide point (refer to the above (4)), the route guide information includes an incoming route IR and an outgoing route OR, and the connection angle CA (FIG. 4). The terminal 1 uses the connection angle CA between the incoming route IR and the outgoing route OR (refer to FIG. 4). The terminal 1 uses the connection angle included in the route guide information to present to the user a direction of travel, such as “turn right (approximately 90 degrees)”, “turn left (approximately 90 degrees)”, “turn right (approximately 120 degrees, for example)”, “turn left (approximately 120 degrees, for example)”, “turn right (approximately 80 degrees, for example), “turn left (approximately 80 degrees, for example), etc. Alternatively, instead of the connection angle of the road, the route guide information may include identification codes indicating the direction of travel as exemplified above for each guide point. Still alternatively, to carry out route guidance, the terminal 1 may use data indicating the accurate shapes of the roads in the vicinity of each guide point to calculate the connection angle between the incoming route and the outgoing route at each guide point.

Even though the terminal 1 carries out route guidance along the recommended route by presenting the information as mentioned in the above (1) to (4), the driver may, inadvertently or intentionally, go out of the recommended route. In this case, if the route guide information includes no road network data except the recommended route, the terminal 1 can no longer carry out route guidance. Therefore, the road network data is included in the route guide information for getting the vehicle back to the recommended route.

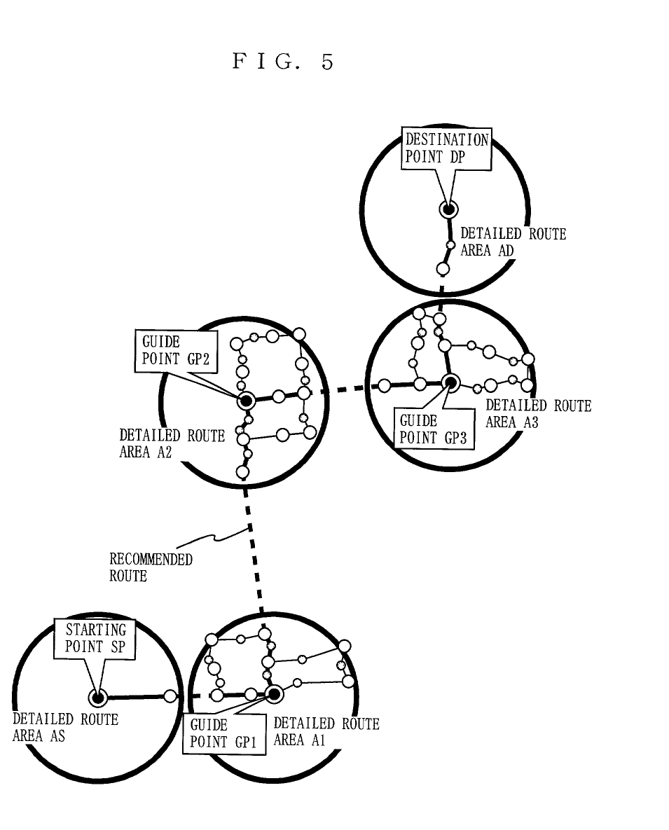

In consideration of the above, a specific example of how to generate route guide information is described with reference to FIG. 5. In FIG. 5, on the recommended route from the starting point SP to the destination point DP, the direction of travel is changed at approximately 90 degrees at three intersections. Therefore, these intersections are set as guide points GP1, GP2, and GP3. Thus, the recommended route shown in FIG. 5 starts at the starting point SP, goes through three guide points GP1, GP2, and GP3, and then reaches the destination point DP. Here, for example, assume that the distance of the route connecting the starting point SP and the destination point GP1 is 7 Km, the distance of the route connecting the guide points GP1 and GP2 is 15 Km, and the distance of the route connecting the guide points GP2 and GP3 is 10 Km, and the distance of the route connecting the guide point GP 3 and the destination point DP is 8 Km.

Next, circle areas each having a predetermined radius (3 Km, for example) centering on the starting point, the destination point, and each guide point are defined as detailed route areas for the respective points. In the example shown in FIG. 5, five detailed route areas AS, A1, A2, A3, and AD are obtained. Furthermore, the data included in the route guide information varies in degree of details depending on inside or outside of the detailed route area. Specifically, the route guide information inside the detailed route area includes guide information required for at that point and also road network data for accurately obtaining the position of the vehicle, and road network data for getting back to the recommended route. In contrast, the route guide information outside the detailed route area includes data required at least for reaching the next point.

As shown in FIG. 3, the route guide information RG is defined with a guide record and a link record. The guide record is data related to a guide point. The route guide information RG is composed of data indicating the number of guide record N and N guide records GR1 to GRN. The link record is data related to a link connecting two intersections. Each guide record GRi is composed of data LRNUM indicating the number of link records M, M link records LR1 to LRM, and inter-guide-point information GG. Each link record is composed of a link attribute LATR, a link shape coordinate string LPNT, link connection information LCON, and guide information GINF. The link attribute LATR represents an attribute of the link, such as the type of the road and the number of lines. The link shape coordinate string LPNT represents a coordinate string of a shape point on the link. The link connection information LCON represents information about how the link branches, connects, or others. The guide information GINF represents the direction of travel at the intersection to which the link is connected. Here, note that each guide record GRi includes only the data about the link within the detailed route area for that point. The inter-route-point information GG is composed of a distance NDIST to the next point and a road name NNAME to be traveled to reach the next point.

With the route guide information, the terminal 1 does not have to store the map data in advance and uses only the route guide information distributed by the center station 2 to carry out detection of the current position of the vehicle, route guidance, and route recovery. In stead of data indicating all intersections and links on the recommended roads, the route guide information includes data varying in degree of details depending on inside or outside of the detailed route area. Thus, the route guide information is reduced in amount while being kept in usefulness. Furthermore, it is possible to reduce communications cost required for distributing the route guide information.

(Processing in the Terminal 1)

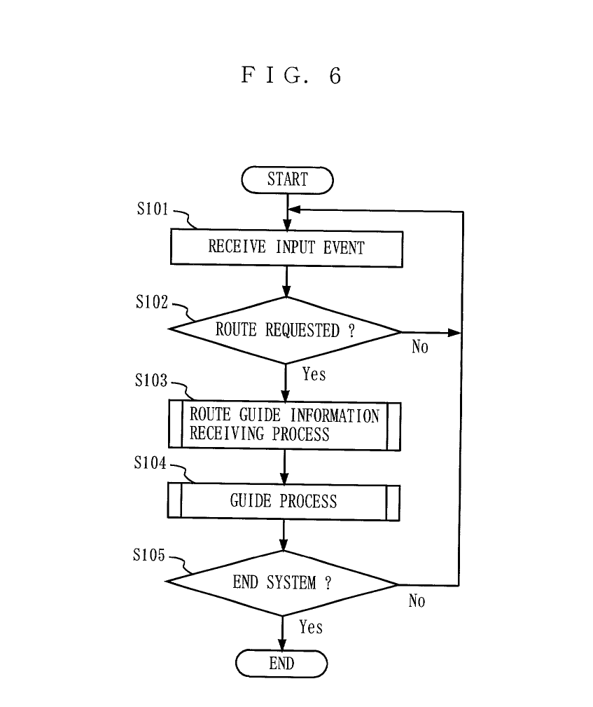

With reference to FIGS. 6 to 11, the processing in the terminal 1 is described. FIG. 6 is a flowchart showing the main processing in the terminal 1. The terminal 1 receives an input event supplied by the user through the first input unit 11 (step S101). The terminal 1 then determines whether the user has requested for a new route or not (step S102). If a new route request is supplied, the procedure goes to step S103. Otherwise, the procedure goes to step S101 for receiving an input event.

In step S103, the terminal 1 carries out a route guide information receiving process. In this process, the terminal 1 transmits a route guide information request message to the center station 2, and receives the relevant route guide information. This process will be described later in detail.

Next, the terminal 1 carries out a guide process (step S104). In this process, the terminal 1 uses the route guide information distributed by the center station 2 to guide the vehicle from the current position to the destination point. In this process, the center station 2 uses the first output unit 16 for present to the user a display of a map, intersections, and arrows, an audio output, or a combination thereof. The guide process will be described later in detail.

Next, the terminal 1 determines whether to end the system or not (step S105). If determining to end, the terminal 1 ends the processing, and otherwise returns to step S101 for carrying out step S101 and thereafter again. The terminal 1 determines to end the system when, for example, the user cuts the power or requests for ending the guide process via the first input unit 11.

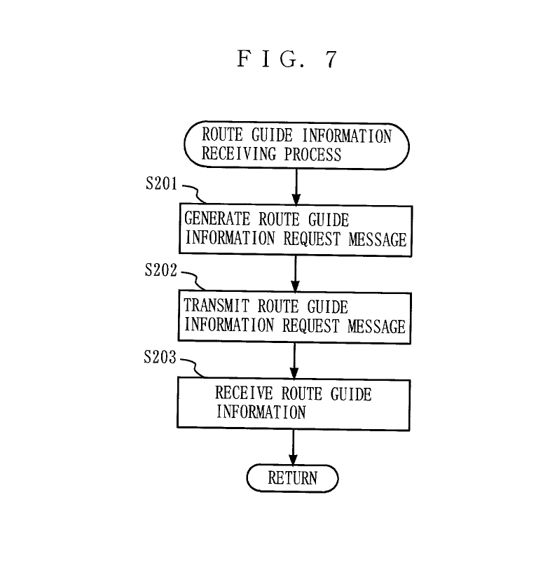

FIG. 7 is a flowchart showing the route guide information receiving process (step S103 of FIG. 6). The terminal 1 generates a message for requesting route guide information (step S201). By way of example only, the terminal 1 sets the longitude and latitude of the current position of the vehicle detected by the position detector 12 as the starting point longitude SPLON and the starting point latitude SPLAT, respectively, for the route guide information request message. Alternatively, the terminal 1 may specify an arbitrary point as the starting point.

Also, the terminal 1 sets the longitude and latitude of the destination point for route search as the destination point longitude DPLON and the destination point latitude DPLAT, respectively. Alternatively, the destination point may be specified by the user directly supplying the address, name, or telephone number of the destination point, narrowing down a genre of the destination point, or searching a database with a keyword. Such database may be stored in the terminal 1 or the center station 2. In the former case, the address, name, telephone number, genre, keyword, or the like may be inputted through the first input unit 11, and a search for the destination point is made by the first arithmetic operation unit 13. In the latter case, a search key such as the address inputted through the first input unit 11 is transmitted to the center station 2. The center station 2 searches the database, and returns the search results to the terminal 1. Furthermore, the database may be stored in another server connected to the communications network 3.

The terminal 1 then uses the first communications unit 14 to send the generated route guide information request message to the uplink UL of the communications network 3 (step S202). At the center station 2; the second communications unit 21 receives the route guide information request message; the second arithmetic operation unit 22 generates the route guide information; and the second communications unit 21 sends the generated route guide information to the downlink DL of the communications network 3. How to generate the route guide information will be described later in detail.

The terminal 1 then uses the first communications unit 14 to receive the route guide information transmitted from the center station 2 (step S203). The received route guide information is temporarily stored in the data storage unit 15 for use in the guide process described later. Note that a communications protocol used for transmitting and receiving the route guide information request message and the route guide information is not particularly unique to the present invention, and therefore not described herein.

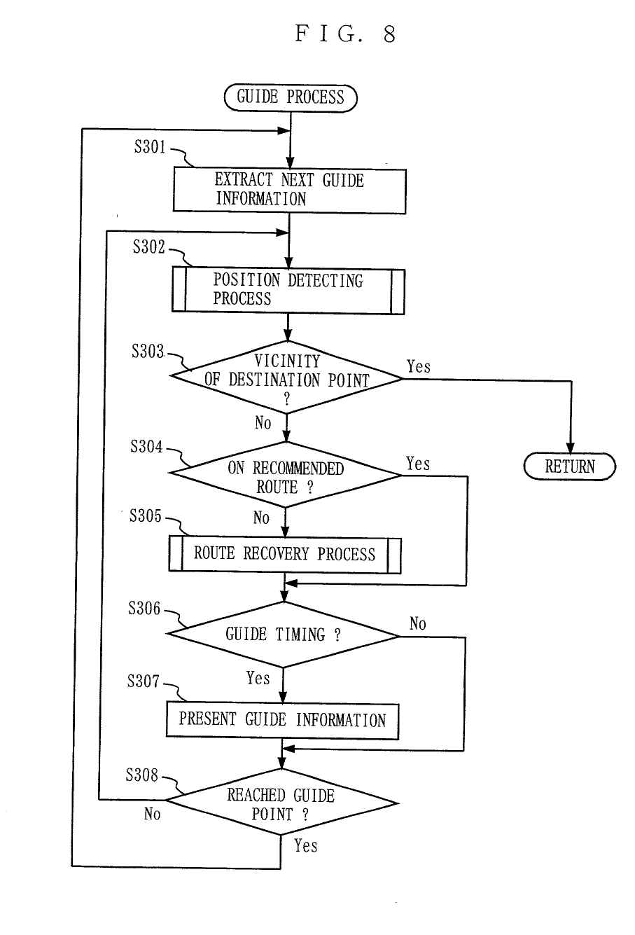

FIG. 8 is a flowchart showing the guide process (step S104 of FIG. 6). From the received route guide information, the terminal 1 extracts the guide information of the next guide point (step S301). Specifically, the terminal 1 extracts, from the route guide information, the name of the road coming to the guide point, the distance to the guide point, the name of the road going out of the guide point, the connection angle between the incoming route and the outgoing route at the guide point, and others.

The terminal 1 then carries out a position detecting process, that is, a process for detecting the current position of the vehicle (step S302), which will be described later in detail. The terminal 1 then determines whether the detected current position is in the vicinity of the destination point or not (step S303). If determining that the current position of the vehicle is in the vicinity of the destination point, the terminal 1 ends the guide process, and otherwise goes to step S304.

In step S304, the terminal 1 determines whether the detected current position is on the recommended road or not. If determining that the current position of the vehicle is not on the recommended road, the terminal 1 carries out the route recovery process (step S305), which will be described later.

The terminal 1 then determines whether it is time to present the route guide information to the driver or not (step S306). This determination is carried out based on the distance from the current position of the vehicle to the next guide point. In the present embodiment, assume herein that the route guide information is presented to the driver 2 Km, 1 Km, 700 m, and 300 m before coming to the next guide point. In this case, the terminal 1 calculates the distance from the current position of the vehicle to the next guide point, and if the calculated distance is either 2 Km, 1 Km, 700 m, or 300 m, the procedure goes to step S307, and otherwise goes to step S308.

In step S307, the terminal 1 presents the route guide information to the driver. The route guide information to be presented is, by way of example only, the name of a road to travel for reaching the next guide point, the distance to the next guide point, an enlarged view of the intersection as the next guide point, the direction of travel at that guide point (go straight, turn right, turn left, etc.), the name of a road branching at the guide point to travel, and others. The first output unit 16 makes the route guide information displayed on a screen or produced in synthesized voice.

The terminal 1 then determines whether the vehicle has reached the next guide point or not (step S308). If the terminal 1 determines that it has not reached yet, the procedure goes to step S302 for carrying out the position detecting process again. Otherwise, the procedure goes to step S301, wherein the terminal 1 extracts guide information for the next guide point, and then carries out the position detecting process again. The terminal 1 repeats the processing from steps S301 to S308 for carrying out the guide process along the recommended route.

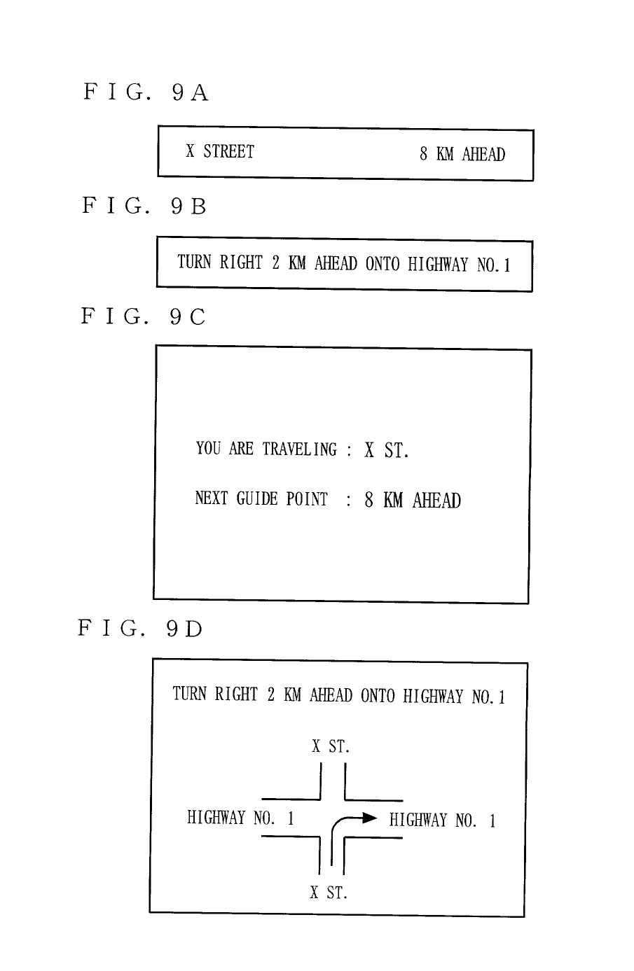

FIG. 9 is an illustration showing examples of a screen displayed on a display unit on the first output unit 16. If the display unit supports text display, text indicating the road to travel for reaching the next guide point and the distance thereto is displayed while the vehicle is traveling until it comes to a point for presenting the route guide information (hereinafter, presentation point) (FIG. 9A). At that point and thereafter (step S307 of FIG. 8), text indicating the distance to the next guide point together with the name of the road to travel after the next guide point and the direction of travel at the next guide point (FIG. 9B). If the display unit supports graphics display, a screen as shown in FIG. 9C is displayed while the vehicle is traveling until it comes to the presentation point. At that point and thereafter, a screen shown in FIG. 9D is displayed in graphics. In either case, the driver can drive the vehicle along the recommended route by referring to the screens as shown in FIGS. 9A and 9B or FIGS. 9C and 9D.

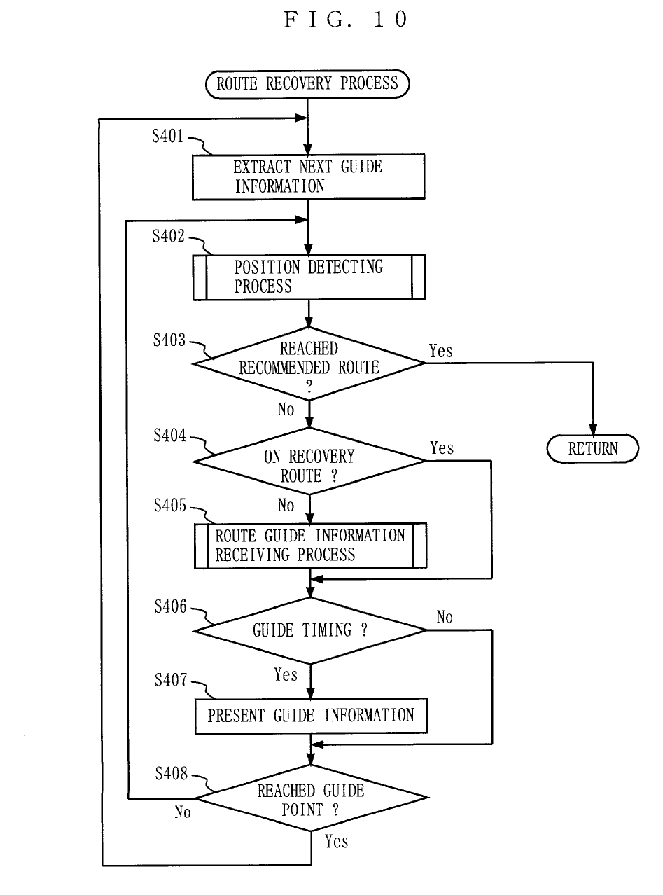

FIG. 10 is a flowchart showing the route recovery process (step S305 of FIG. 8). The route recovery process is carried out when the vehicle goes out of the recommended route. In addition to the road network data of the recommended route, the route guide information includes road network data of a recovery route for getting the vehicle back to the recommended route when the vehicle makes a wrong turn at any guide point or a point prior or subsequent thereto. In the route recovery process, the road network data of the recovery route included in the route guide information is used for getting the vehicle back to the recommended route.

The terminal 1 extracts, from the route guide information, the guide information of the next guide point on the recovery route (step S401). Specifically, the terminal 1 extracts the name of a road coming to the guide point, the distance to the guide point, the name of a road going out of the guide point, the connection angle between the incoming route and the outgoing route at the guide point, and others.

The terminal 1 then carries out, as with step S302 in the guide process, the position detecting process (step S402). The terminal 1 then determines whether the detected current position is on the recommended route or not (step S403). If determining that the current position is on the recommended route, the terminal 1 ends the route recovery process, and otherwise the procedure goes to step S404.

In step S404, the terminal 1 determines whether the detected current position is on the recovery route or not. If determining that the current position is not on the recovery route, the terminal 1 determines that further route guidance cannot be made with the route guide information currently used, and receives again route guide information from the current position to the destination point (step S405).

The terminal 1 then determines whether it is time to present the route guide information to the driver or not (step S406) in a manner similar to that in step S306 of the guide process. If it is time to do so, the terminal 1 presents the route guide information as required (step S407) in a manner similar to that in step S307 of the guide process.

The terminal 1 then determines whether the vehicle has come to the next guide point or not (step S408). If the terminal 1 determines that the vehicle has not come yet, the procedure goes to step S402 for the position detecting process again. Otherwise, the procedure goes to step S401, wherein the terminal 1 extracts the guide information of the next guide point, and then again carries out the position detecting process. The terminal 1 repeats the processing from steps S401 to S408 for carrying out route guidance in order to get the vehicle back to the recommended route or to newly receive the route guide information RG.

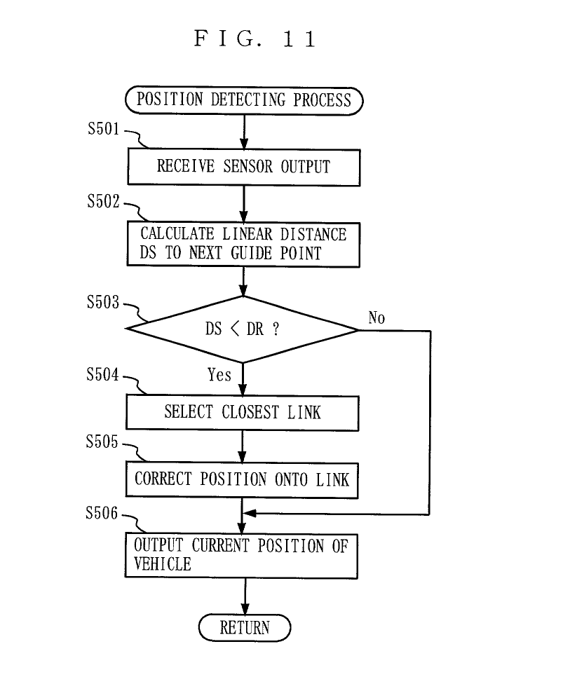

FIG. 11 is a flowchart showing the position detecting process (step S302 of FIG. 8, step S402 of FIG. 9). Described below is a case where the position detector 12 includes a GPS sensor having a GPS antenna and a GPS receiver.

The terminal 1 receives data supplied by the GPS sensor (step S501). The supplied data includes longitude and latitude coordinates representing the absolute position of the vehicle on the earth, a travel direction, and a traveling speed. The terminal 1 then calculates a linear distance DS from the point represented by the received longitude and latitude coordinates to the next guide point (step S502).

The terminal 1 then compares with the linear distance DS with a radius DR of the detailed route area (step S503). In the example of FIG. 5, the radius of the detailed route area is 3 Km. If the linear distance DS is shorter than the radius DR, the detailed road network data including data of the area surrounding the current position is available because it is included in the route guide information. Therefore, the procedure goes to step S504 for calculating the accurate current position of the vehicle. If the linear distance DS is equal or longer than the radius DR, the detailed road network data including data of the area surrounding the current position is not available because it is not included in the route guide information. Therefore, the procedure goes to step S506. In this case, the terminal 1 regards the value supplied by the position detector 12 as a value representing the current position of the vehicle.

In step S504, the terminal 1 selects a link closest to the current position of the vehicle. Specifically, the terminal 1 calculates a distance from the current position represented by the longitude and latitude coordinates received in step S501 to each road included in the route guide information RG, and a difference between the travel direction of the vehicle received in step S501 and the direction of each road included in the route guide information. The terminal 1 then selects a road having a minimum distance to the current position and a minimum difference in direction from the travel direction as a road where the vehicle is most likely located. The terminal 1 then corrects the current position of the vehicle to a point where the selected road meets a normal thereto from the current position (step S505).

The terminal 1 then outputs the current position of the vehicle (step S506). Specifically, if the linear distance DS to the next guide point is shorter than the radius DR of the detailed route area, the terminal 1 outputs, as the current position of the vehicle, the position corrected to a position on the road included in the route guide information. Otherwise, the terminal 1 outputs the longitude and latitude coordinates outputted from the position detector 12.

(Processing in the Center Station 2)

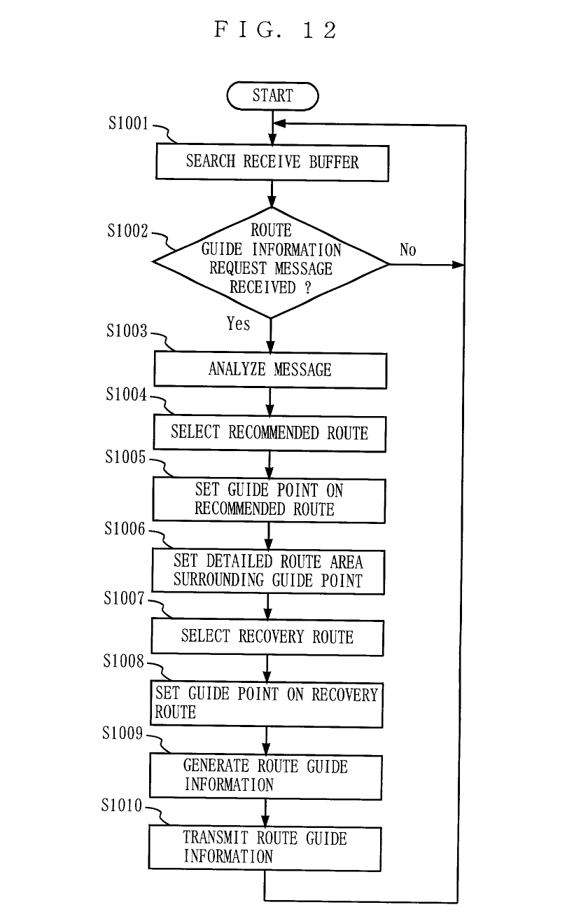

With reference to FIG. 12, described is the processing in the center station 2. In the center station 2, a server program for carrying out a process shown in FIG. 12 is operated, keeping the center station 2 in a wait state for a route guide information request message transmitted from the terminal 1. The center station 2 searches a receive buffer for receiving various message from the terminal 1 (step S1001), determining whether to have received any route guide information request message from the terminal 1 or not (step S1002). If the terminal 1 determines to have received the route guide information request message, the procedure goes to step S1003. Otherwise, the procedure returns to step S1001 for waiting for any route guide information request message.

The center station 2 analyzes the received message to find the starting point longitude SPLON, the starting point latitude SPLAT, the destination point longitude DPLON, and the destination point latitude DPLAT (step S1003). The starting point longitude SPLON and the starting point latitude SPLAT represent the starting position for route search, and the destination point longitude DPLON and the destination point latitude DPLAT represent the destination point for route search.

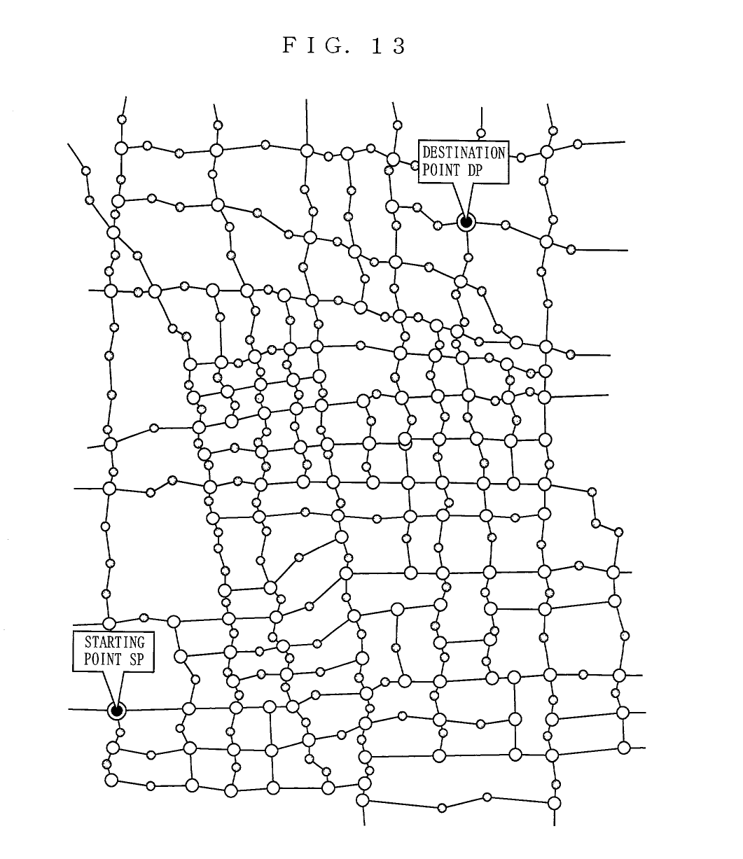

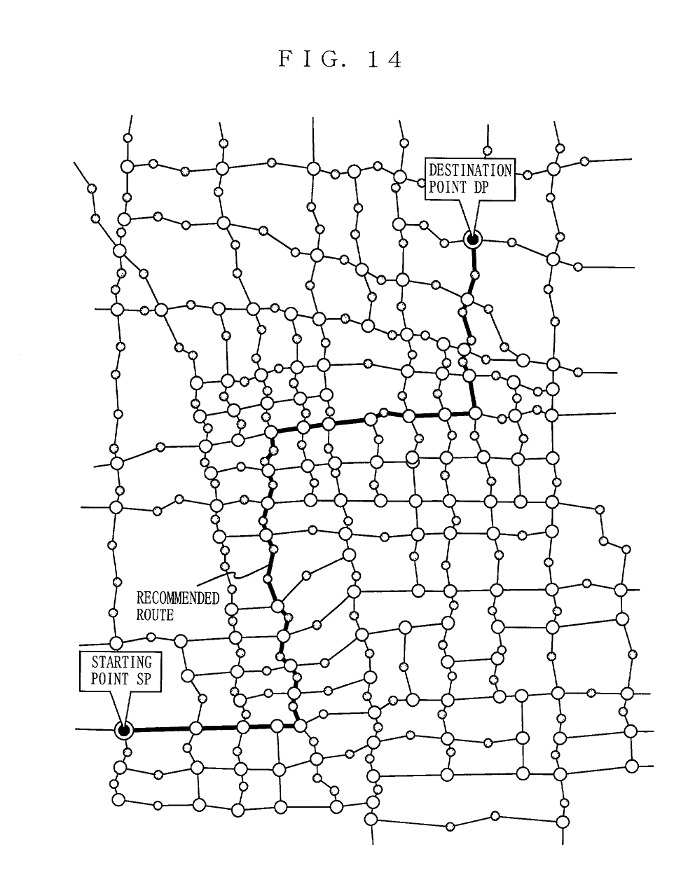

The center station 2 then selects a recommended route from the specified starting point to the specified destination point (step S1004). The center station 2 refers to the road network data in a vector format stored in the map data storage unit 23 for finding a recommended route with a route search scheme based on the Dijkstra algorithm or the A-star algorithm. For example, a recommended route from the starting point SP to the destination point DP on the road network data shown in FIG. 13 is so found as a route represented by a bold line shown in FIG. 14.

The center station 2 then sets, on the found recommended route, guide points where the route guide information is to presented to the driver (step S1005). For example, the center station 2 sets, as the guide points, the following two types of intersections: intersections where the name of the road is changed, and intersections where the direction of travel is changed more than a predetermined threshold ANG. In the latter case, the center station 2 first calculates the connection angle CA between the incoming route IR and the outgoing route OR at the intersection. If the calculated connection angle is larger than the threshold ANG (±30 degrees, for example), the center station 2 sets the intersection as the guide point (refer to FIG. 4).

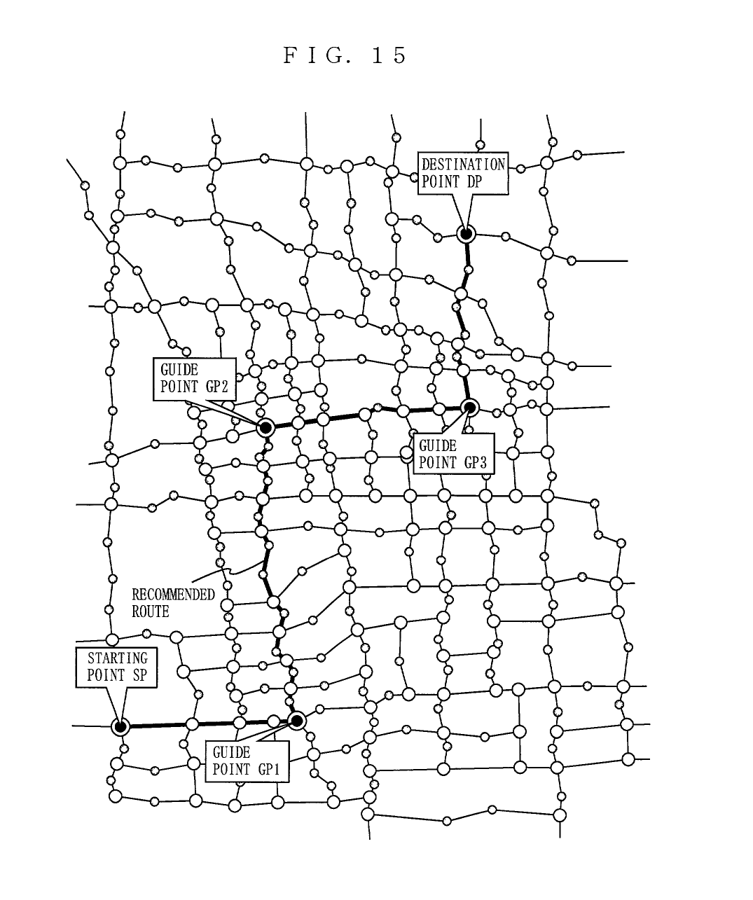

FIG. 15 is an example illustration showing the results of setting the above two types of intersections on the recommended route as the guide points. In this example, three intersections GP1, GP2, and GP3 located on the recommended route are set as the guide points. Note that the guide points are not restricted to the above two types of intersections, but may be any point according to the intentions of the designer. For example, intersections where the driver are prone to take a wrong route may be set as the guide points.

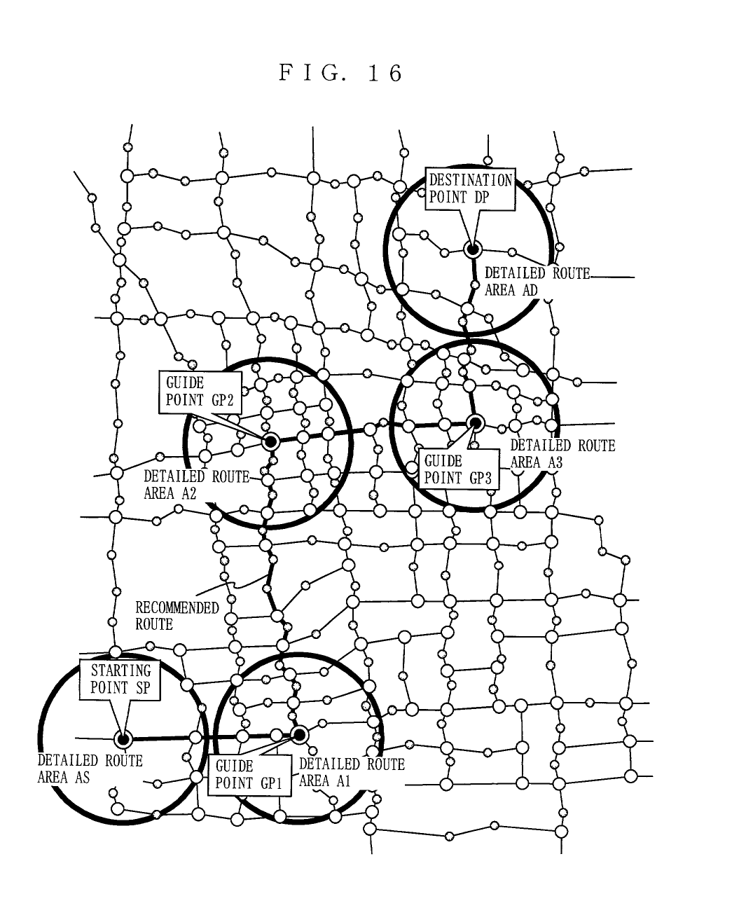

The center station 2 sets a detailed route area surrounding each guide point (step S1006). As described above, the center station 2 generates route guide information including data varying in degree of details depending on inside or outside of the detailed route area. The detailed route area defines an area whose route guide information should be detailed. FIG. 16 is an example illustration showing the results of setting the detailed route area surrounding each guide point shown in FIG. 15. In this example, set as the detailed route areas are circle areas AS, A1, A2, A3, and AD within a 3-Km radius of the starting point SP, the guide points GP1, GP2, GP3, and the destination point DP, respectively. Note that the shape of the detailed route area is not restricted to be a circle, but may be a rectangle or other shapes. Also, the shapes and sizes of the detailed route areas may be varied based on various conditions.

The center station 2 finds a recovery route for getting the vehicle back to the recommended route (step S1007). To find the recovery route, two schemes can be taken. In a first scheme, several routes are selected as the recovery routes from within the detailed route area. In a second scheme, the entire road network data within the detailed route area is taken as the recovery routes.

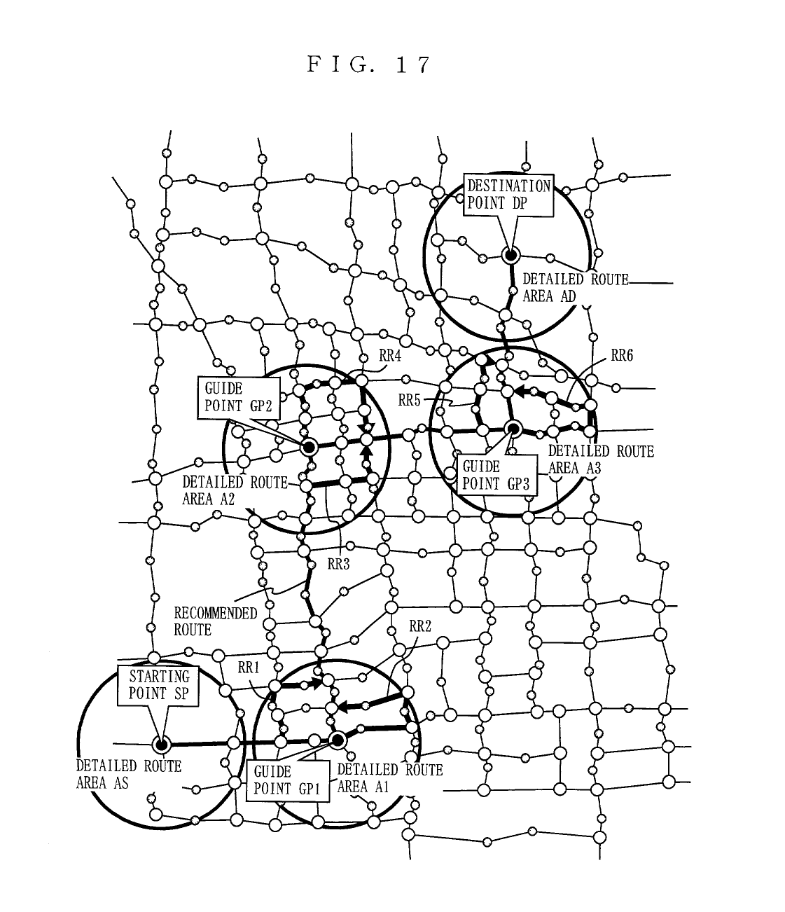

In the first scheme, the center station 2 uses a route searching method based on the Dijkstra algorithm or the A-star algorithm to find a recovery route in a case where the vehicle has made a wrong turn at the intersection preceding to the guide point, and a recovery route in a case where the vehicle erroneously has gone straight through the guide point. If this method is applied to the detailed route areas shown in FIG. 16, the results are as shown in FIG. 17. In this example, six recovery routes are found. A recovery route RR1 is to get the vehicle back to the recommended route in a case where the vehicle has made a wrong turn at the intersection preceding to the guide point GP1. A recovery route RR2 is to do so in a case where the vehicle erroneously has gone straight through the guide point GP1. A recovery route RR3 is to do so in a case where the vehicle has erroneously made a right turn at the intersection preceding to the guide point GP2. A recovery route RR4 is to do so in a case where the vehicle has erroneously gone straight to the guide point GP2. A recovery route RR5 is to do so in a case where the vehicle has erroneously made a left turn at the intersection preceding to the guide point GP3. A recovery route RR6 is to do so in a case where the vehicle has erroneously gone straight through the guide point GP3. In addition to the above, the center station 2 may find a recovery route at every intersection on the recommended route within the detailed route area. If the vehicle is traveling with reference to the route guide information including the recovery routes found in the first method when the vehicle goes out of the recommended route, the terminal 1 carries out route guidance according to the recovery routes included in the route guide information for getting the vehicle back to the recommended route. Therefore, in the first scheme, the terminal 1 does not have to search for recovery routes.

In the second scheme, the center station 2 takes the entire road network data within the detailed route areas as the recovery routes. If the vehicle is traveling with reference to the route guide information including the recovery routes found in the second scheme when the vehicle goes out of the recommended route, the terminal 1 has to find a recovery route by using the road network data included in the route guide information. In any event, according to the first or second scheme, the route guide information includes information required for getting the vehicle back to the recommended route. Therefore, the terminal 1 can carry out route guidance even though the vehicle goes out of the recommended route.

The center station 2 then sets guide points where the guide information should be presented (step S1008). Intersections to be set as the guide points are similar to those in step S1005.

The center station 2 then finds guide information for guiding the driver along the selected recommended route and the recovery route based on the map data stored in the map data storage unit 23, and generates the route guide information including the guide information (step S1009). The center station 2 then sends the generated route guide information via the second communications unit 21 to the downlink DL of the communications network 3 (step S1010). The communications protocol for use in transmission and reception of the route guide information is not particularly unique to the present invention, and therefore not described herein.

As stated above, in the route guide information distributing system according to the present embodiment, the route guide information distributed from the center station to the terminal includes data varying in degree of details depending on the areas surrounding the guide points or the other areas. Set as the guide points are intersections where the name of the road is changed and intersections where the direction of travel is changed more than a predetermined angle. In the areas surrounding the guide points, not only the guide information but the detailed road network data and the road network data other than the recommended route are included. In the other areas, only minimum guide information required is included. Thus, the route guide information can be reduced in amount while being kept in usefulness.

In the present embodiment, the center station 2 distributes to the terminal 1 only the route guide information. Alternatively, the center station 2 may also distribute a route guidance program using the route guide information. In this case, the terminal 1 carries out route guidance using the route guide information and the program both distributed by the center station 2.

### SECOND EMBODIMENT

The construction of a route guide information distributing system according to a second embodiment of the present invention is the same as that according to the first embodiment. The second embodiment is different from the first embodiment in the processes carried out by the first and second arithmetic operation units 13 and 22. Therefore, the system construction is not described herein, while the difference in the processes carried out by the arithmetic operation units are described below.

(Features of the Present Embodiment)

The second embodiment is similar to the first embodiment in that the center station 2 distributes, upon request, the route guide information including the data varying in degree of details depending on the distance from the guide point, and that the terminal 1 carries out route guidance using the distributed route guide information. In contrast, the second embodiment is different from the first embodiment in that the terminal 1 transmits information about a path actually traveled by the vehicle (hereinafter, traveled path information) to the center station 2. That is, the terminal 1 stores traveled path information on a time series, and then transmits the traveled path information on a predetermined timing to the center station 2. The center station 2 uses the received traveled path information to carry out the subsequent processes such as generating route guide information and searching for a route.

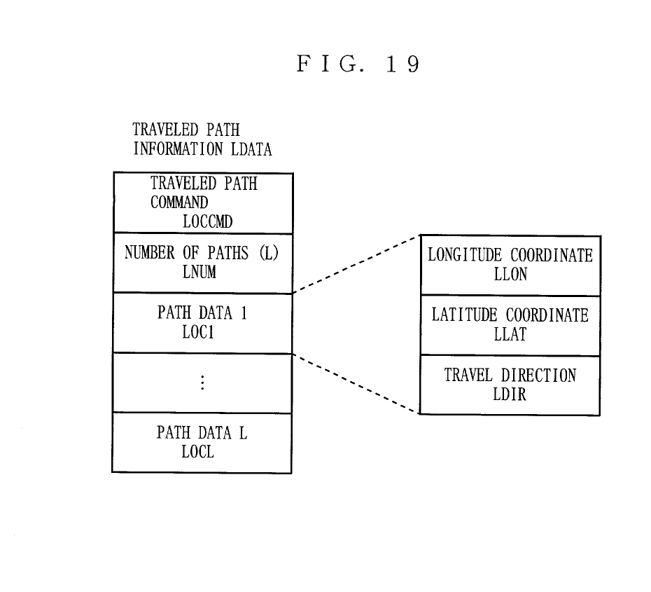

FIG. 19 is an illustration showing the data structure of the traveled path information transmitted from the terminal 1 to the center station 2. In FIG. 19, traveled path information LDATA is composed of a traveled path command LOCCMD, the number of traveled paths LNUM taking a value of L, and L pieces of path data LOC1 to LOCL. The traveled path command LOCCMD indicates that this data indicates traveled path information. Each piece of path data LOCi is composed of a longitude coordinate LLON, a latitude coordinate LLAT, and a travel direction LDIR, representing coordinates of a point actually traveled by the vehicle. In the longitude coordinate LLON and the latitude coordinate LLAT, a longitude coordinate and a latitude coordinate received by the position detector 12 are set. In the travel direction LDIR, a travel direction detected by the position detector 12 is set. Note that these values included in each path data are not the ones after correction onto roads by map matching, but the ones outputted by the position detector 12.

With the traveled path information transmitted from the terminal 1 to the center station 2, the following two effects can be obtained. Firstly, the center station 2 can update the map data based on the traveled path information. More specifically, the center station 2 refers to the received traveled path information to carry out such processes as adding a new road; deleting a closed road; and adding and correcting network connection information, the shape of a road, and traffic regulation information. Thus, the center station 2 can generate, upon request, route guide information using the latest road network data reflecting the actual road states. Using the latest route guide information, the terminal 1 can carry out route guidance.

Secondly, the center station 2 can optimize route search processing based on the traveled path information. Specifically, the center station 2 refers to the received traveled path information to correct the weight of cost applied for route search to the road network data stored in the map data storage unit 23. Thus, the center station 2 can generate, upon request, route search information including routes suited for the preferences of the user or best possible routes reflecting the actual state

(Processing in the Terminal 1)

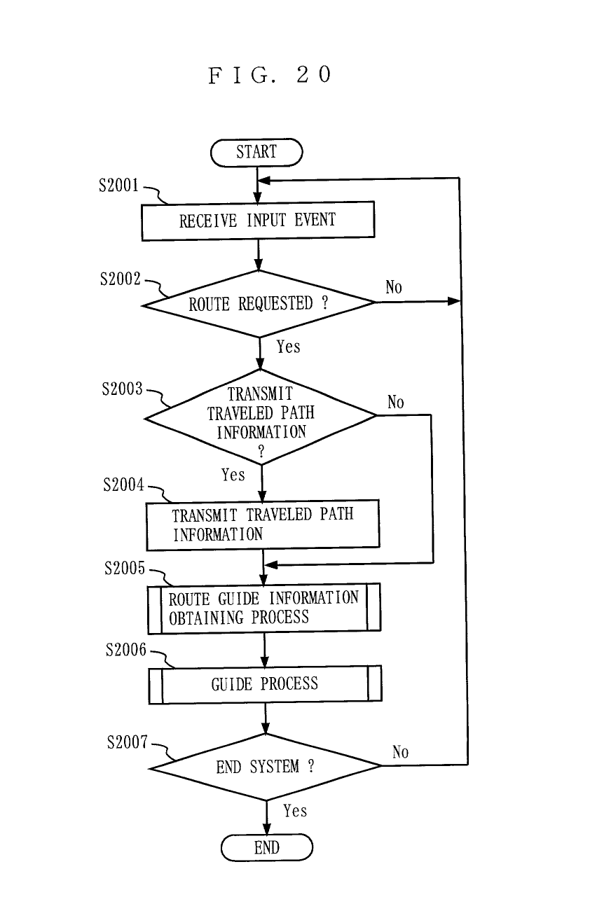

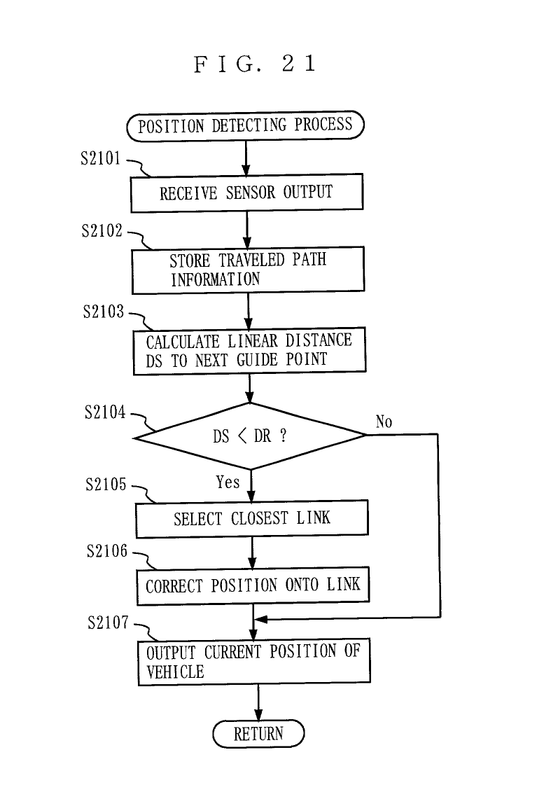

With reference to FIGS. 20 and 21, described is the processing in the terminal 1. FIG. 20 is a flowchart showing the main processing in the terminal 1. As with the first embodiment, the terminal 1 receives an input event from the user (step S2001). If the user requests for new route guide information, the procedure goes to step S2003 (step S2002).

Upon request for new route guide information from the user, the terminal 1 determines whether to transmit the traveled path information to the center station 2 or not (step S2003). When determining to transmit the traveled path information, the terminal 1 transmits to the center station 2 the traveled path information obtained by the previous travel (step S2004). The terminal 1 may determine to transmit the traveled path information only when the driver allows, via the first input unit 11, the traveled path information to be transmitted. Alternatively, the terminal 1 may unconditionally determine to transmit the traveled path information. In step S2004, the terminal 1 reads the traveled path information from the data storage unit 15 onto the main memory, and then sends the read information to the uplink UL of the communications network 3 via the first communications unit 14. The center station 2 receives the traveled path information transmitted from the terminal 1 for use in updating the road network data stored in the map data storage unit 23, learning route search processing, etc.

Next, as with the first embodiment, the terminal 1 carries out the route guide information process (step S2005) and the guide process (step S2006). The guide process of step S2006 is similar to that of the first embodiment, but different therefrom in that the traveled path information is obtained in the position detecting process. The position detecting process according to the present embodiment (FIG. 21) includes the position detecting process according to the first embodiment (FIG. 11) and further a process for storing the traveled path information (S2102 of FIG. 21). The terminal 1 obtains the current position of the vehicle using the position detector 12 (step S2101), and then adds the obtained current position to the traveled path information stored in the data storage unit 15 (step S2102). Thus, in the guide process of step S2006, the terminal 1 guides the vehicle from the starting point SP to the destination point DP while gathering the traveled path information.

The terminal 1 then determines whether to end the system (step S2007). When determining to end the system, the terminal 1 ends the processing. Otherwise, the procedure returns to step S2001 for further processing.

(Processing in the Center Station 2)

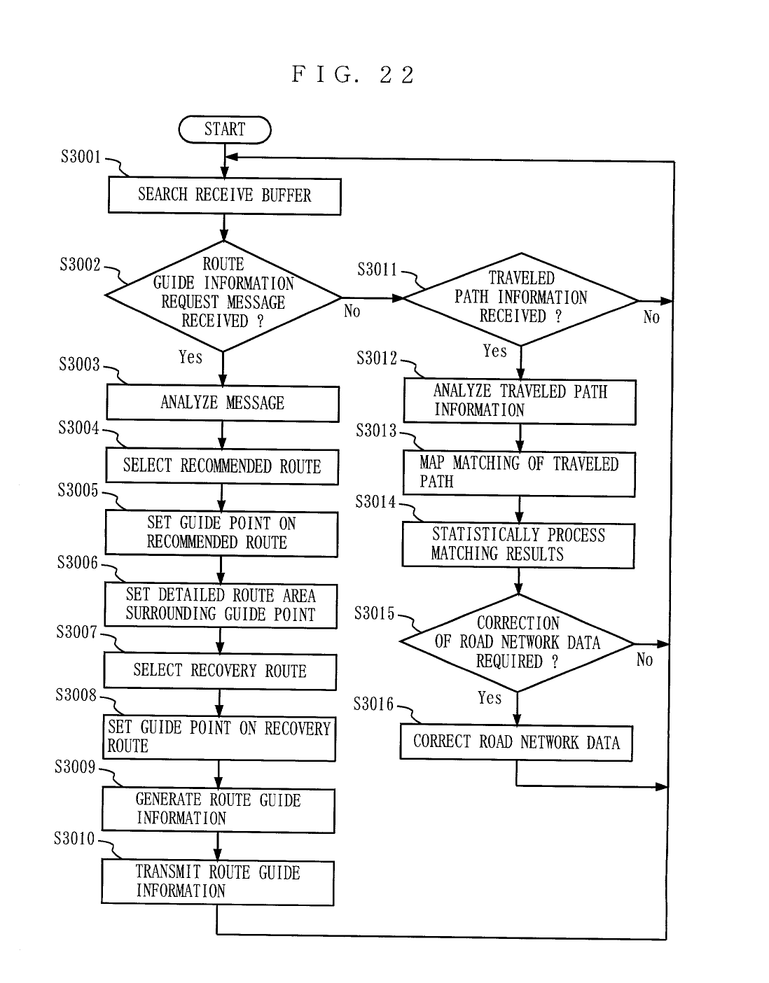

With reference to FIG. 22, described is the processing in the center station 2. FIG. 22 is a flowchart showing the main processing in the center station 2. The flowchart shown in FIG. 22 is similar to the flowchart shown in FIG. 12 according to the first embodiment, but provided with a process in a case when the center station 2 receives a message other than the route guide information request message (steps S3011 to S3016). The processing in steps S3001 to S3010 is the same as that in the first embodiment, and therefore not described herein.

When receiving a message other than the route guide information request message, the center station 2 determines whether the received message is traveled path information transmitted from the terminal 1 or not (step S3011). If the received message is traveled path information, the procedure goes to step S3012. Otherwise, the procedure goes to step S3001, wherein the center station 2 further waits for a message.

The center station 2 then analyzes the received traveled path information to find the path data (step S3012). The center station 2 then matches the found path data with the road network data stored in the map data storage unit 23 (step S3013). In this map matching, the center station 2 reads the road network data stored in the map data storage unit 23 onto the main memory. Then, for each of L pieces of path data included in the traveled path information, the center station 2 selects, from among the read road network data, a road link whose linear distance DIST from the coordinate position included in the path data is the shortest and whose angular difference between the travel direction and the road direction included in the path data is the smallest. Furthermore, if the linear distance DIST and the angular difference ANG each has a value smaller than a predetermined threshold, the center station 2 draws a normal to the selected road from the coordinate position of the path data, and corrects the coordinate position of the path data to a point where the road meets the normal. For example, assume herein that the threshold of the linear distance DIST is 10 m, the threshold of the angular difference ANG is approximately five degrees. In this case, to select a road link matching with the path data from among the road network data stored in the map data storage unit 23, the center station 2 stores road link identifiers in the map data storage unit 23. Here, the road link identifiers are identification numbers uniquely assigned to respective road links included in the road network data stored in the map data storage unit 23. Note that, to improve the matching accuracy, the center station 2 may carry out map matching by using variously devised algorithms.

The center station 2 then carries out a statistical method on the results of map matching(step S3014). Specifically, the center station 2 makes a link-to-path list with path data recorded for each road link matching therewith.

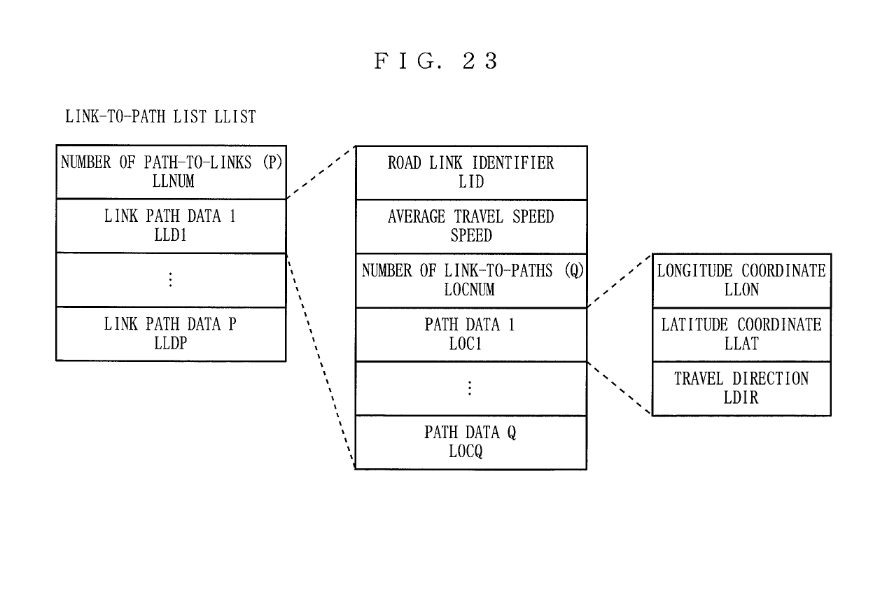

FIG. 23 is an illustration showing the data structure of a link-to-path list LLIST. In FIG. 23, the number of path-to-links LLNUM having a value of P indicates the number of road links for matching in the road network data stored in the map data storage unit 23. The link-to-path list LLIST contains P pieces of link path data LLD1 to LLDP. Each link path data is composed of a road link identifier LID, an average travel speed SPEED, the number of link-to-paths LOCNUM having a value of Q, and Q pieces of path data LOC1 to LOCQ.

As stated above, the road link identifier LID is an identifier uniquely assigned to a road link included in the road network data stored in the map data storage unit 23, and used for relating the link path data to the road link. The number of link-to-paths LOCNUM indicates the number of pieces of path data matching with the road link that corresponds to the road link identifier LID. The path data LOC1 to LOCQ are a series of path data that matches the road link corresponding to the road link identifier LID. The average travel speed SPPED is an average travel speed when the vehicle travels the road link corresponding to the road link identifier LID, and calculated by dividing the distance traveled by the vehicle by the traveling time taken for that road link. Note that the traveling time can be calculated by a sampling cycle when the path data is generated.

The center station 2 updates the link-to-path list whenever receiving the traveled path information from the terminal 1. Thus, the information about the path actually traveled by the vehicle is accumulated for each road link included in the map data storage unit 23. Also, for path data that does not match with any road link included in the road network data stored in the map data storage unit 23, the center station 2 makes a non-link-to-path list (not shown) similar in structure to the link-to-path list to store data.

The center station 2 then determines based on the link-to-path list LLIST and the non-link-to-path list NLLIST whether to correct the road network data stored in the map data storage unit 23 (step S3015). If finding a road link included in the non-link-to-path list but not in the road network data, the center station 2 determines to add the road link to the road network data. On the other hand, if finding a road link included in the road network but not in the link-to-path list, the center station 2 determines to delete the road link from the road network data. Note that the center station 2 may make a determination in step S3015 based on a result of visual recognition by the operator who looks at the road network data stored in the map data storage unit 23 and the path data contained in the link-to-path list and the non-link-to-path list simultaneously displayed on the display device of the second output unit 25. Alternatively, the determination in step S3015 may be made after the actual road states are studied. In both cases, it is possible to recognize at a glance the need for adding which road within which area or updating the road network data. This greatly improves efficiency compared with a case the entire road network data of the area covered by the center station 2 has to be studied. Also, the link-to-path list contains the road link identifier LID for specifying the road link that corresponds to the path data. Thus, it is possible to easily specify which road link should be updated in the road network data.

Next, based on the determination in step S3015, the center station 2 corrects the road network data stored in the map data storage unit 23 (step S3016). The center station 2 may correct the road network data by programmed automatic processing based on the link-to-path list and the non-link-to-path list both made thereby, or by using a program having a graphical user interface to receive an interactive instruction from the operator. In both cases, the road network data stored in the map data storage unit 23 contains the link identifier LID for specifying the road link. Therefore, the road link to be corrected can be easily recognized.

Also, the link-to-path list contains the average travel speed SPEED of the vehicle when actually traveling the road link. Therefore, for the route search process using the road network data stored in the map data storage unit 23, the average travel speed SPEED can be used as weight of cost assigned to the road link for selecting best possible route reflecting the actual road states.

As stated above, in the route guide information distributing system according to the present embodiment, distributed from the center station to the terminal is the route guide information including data varying in degree of details depending on the distance from the guide point. From the terminal to the center station, the traveled path information indicating the path actually traveled by the vehicle is transmitted. Thus, using the received traveled path information, the center station 2 can reflect the latest traveling of the vehicle onto the map data. Using thus updated map data, the terminal 1 can carry out route guidance based on the latest, best possible route guide information reflecting the actual states. Moreover, maintenance and management cost of the map data in the center station 2 can be reduced, thereby leading to reduction in cost of using the route guide information in the terminal 1.

### THIRD EMBODIMENT

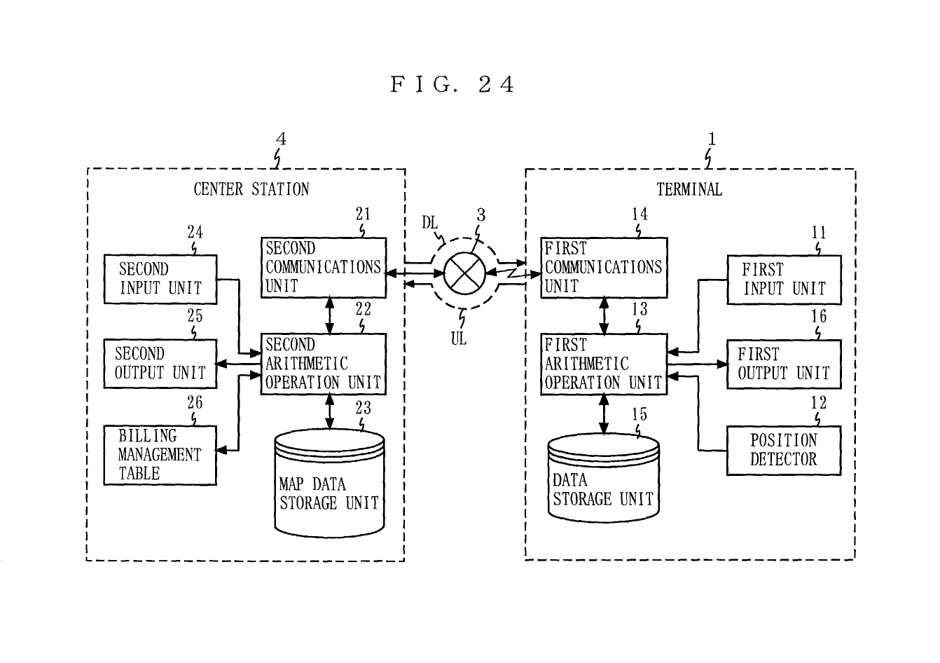

FIG. 24 is a block diagram illustrating the construction of a route guide information distributing system according to a third embodiment of the present invention. The route guide information distributing system shown in FIG. 24 is constructed of the terminal 1 and a center station 4. The terminal 1 is the same in structure as that according to the second embodiment. The center station 4 is similar to the center station 2 according to the second embodiment with a billing management table 26 added thereto, being characterized in that distribution of the route guide information is billed. The components that are same in structure as those in the second embodiment are provided with the same reference numerals, and not described herein.

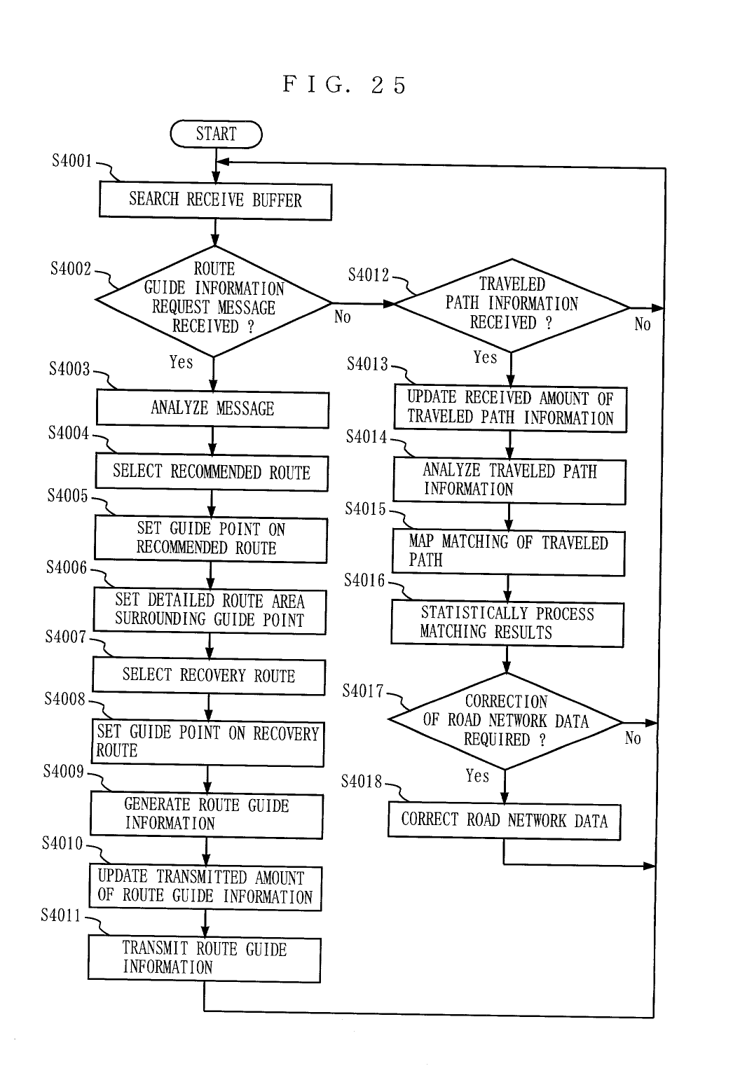

FIG. 25 is a flowchart showing the main processing in the center station 4. The flowchart shown in FIG. 25 is similar to the flowchart according to the second embodiment (FIG. 22), but provided with two processes (steps S4010 and S4013) for updating the billing management table 26. The processing other than steps S4010 and S4013 is the same as that according to the second embodiment, and therefore not described herein.

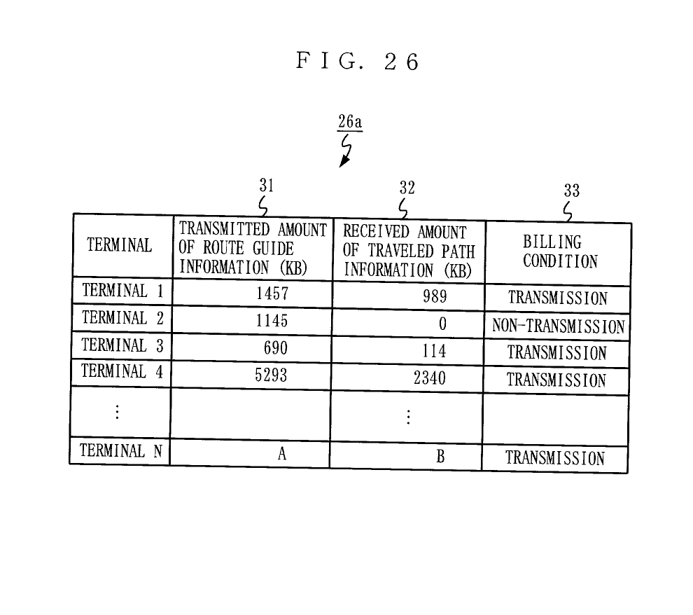

FIG. 26 is an example illustration of the billing management table 26. A billing management table 26a contains, for each terminal managed by the center station 4, a transmitted amount of route guide information 31, a received amount of traveled path information 32, and a billing condition 33. The transmitted amount of route guide information 31 represents the amount of route guide information transmitted to each terminal 1. The received amount of traveled path information 32 represents the amount of traveled path information received from each terminal 1. The billing condition 33 represents whether or not the terminal 1 transmits the traveled path information. If the billing condition 33 indicates “transmission”, the terminal 1 transmits the traveled path information to the center station 4. If the billing condition 33 indicates “non-transmission”, the terminal 1 does not transmit the traveled path information to the center station 4. The billing condition 33 is stipulated, for each terminal 1, in a contract between the user of the terminal and a company operating the center station 4 (hereinafter, operation company), for example. The stipulated billing condition 33 is supplied by the second input unit 24, and stored in the billing management table 26.

With reference to FIG. 25, in step S4010, the center station 4 updates the transmitted amount of route guide information 31 included in the billing management table 26a. In step S4013, the center station 4 updates the received amount of traveled path information 32 included in the billing management table 26a. In details, in step S4010, the center station 4 adds the amount of route guide information generated in step S4009 to the transmitted amount of route guide information 31 of the terminal receiving that route guide information. Also, in step S4013, the center station 4 adds the amount of traveled path information received in step S4001 to the received amount of traveled path information 32 of the terminal transmitting that traveled path information.

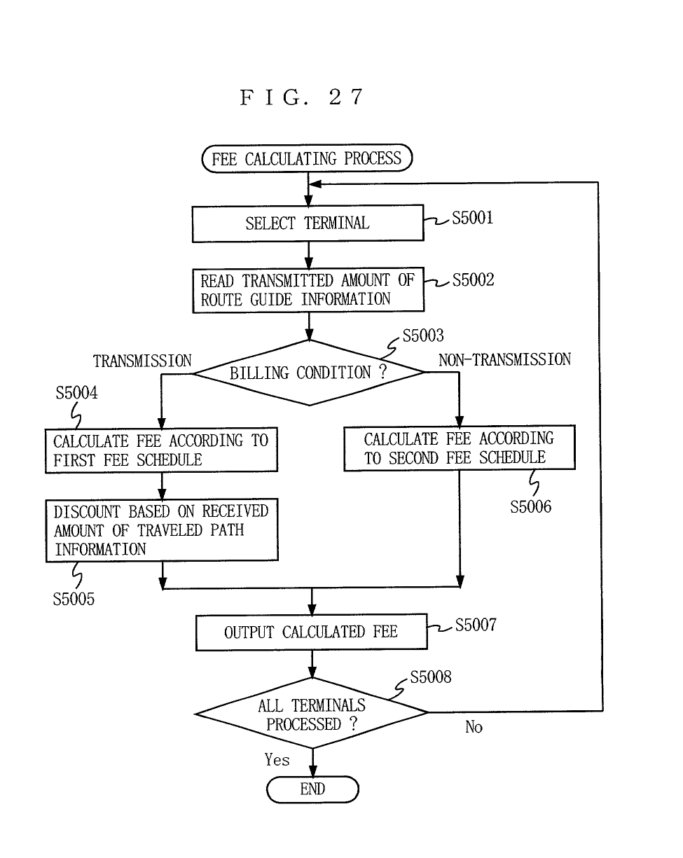

In addition to the main processing shown in FIG. 25, the center station 4 carries out a fee calculating process shown in FIG. 27 at regular intervals (every end of the month, for example). In the fee calculating process, the center station 4 first selects a specific terminal from the billing management table 26a (step S5001). The center station 4 then reads the transmitted amount of route guide information 31 of the selected terminal (step S5002). The center station 4 then checks the billing condition 33 of the terminal (step S5003). If the billing condition 33 indicates “transmission”, the procedure goes to step S5004. If the billing condition 33 indicates “non-transmission”, the procedure goes to step S5006.

If the billing condition 33 indicates “transmission”, the center station 4 calculates a fee for distributing the route guide information according to a predetermined first fee schedule based on the read transmitted amount of route guide information 31 (step S5004). On the other hand, if the billing condition 33 indicates “non-transmission”, the center station 4 calculates a fee for distributing the route guide information according to a predetermined second fee schedule based on the read transmitted amount of route guide information 31 (step S5006). Here, the fee calculated according to the first fee schedule is so defined as to be always less expensive than the fee calculated according to the second fee schedule. For example, assuming that a fee Y is proportional to the received amount of route guide information X, coefficients K₁ and K₂ are selected, where K₁<K₂. Then, the fee Y is calculated using an equation Y=K₁×X in the first fee schedule or an equation Y=K₂×X in the second fee schedule. Alternatively, an coefficient K and a positive number C may be selected, and then the fee Y may be calculated using an equation Y=K×X−C in the first fee schedule or an equation Y=K×X in the second fee schedule.

If the billing condition 33 indicates “transmission”, the center station 4 calculates the fee according to the first fee schedule, and then discounts the calculated fee based on the received amount of traveled path information 32 (step S5005). At this time, assume herein that the center station 4 discounts the calculated fee more as the received amount of traveled path information 32 becomes larger.

The center station 4 then outputs to the second output unit 25 the calculated fee with information for identifying the terminal 1 (step S5007). The center station 4 then determines whether the fee calculating process has been carried out on all terminals (step S5008). If the process has been carried out on all terminals, the center station 4 ends the process. If not all terminals have been processed, on the other hand, the procedure returns to step S5001, where the process is carried out on any remaining terminal.

The operation company charges the user of the terminal the fee calculated in the fee calculating process shown in FIG. 27. At the time of making a contract with the operation company for receiving the route guide information, the user of the terminal 1 is informed that a less expensive fee is applied for distribution of the route guide information if the user allows the traveled path information to be transmitted from the terminal 1 to the center station 4. The user then studies the advantages and disadvantages of transmitting the traveled path information. The main advantage is that a less fee is applied, and the main disadvantage is that user's privacy is impaired. If the first fee schedule is more reasonable than the second one, many users may agree to transmit their traveled path information in order to enjoy the advantage.

As such, for distribution of the route guide information, the center station applies either one of the two different fee schedules to the terminal depending on whether the terminal allows transmission of the traveled path information or not. This provides the center station with a much better chance of collecting more traveled path information, thereby improving the accuracy of the map data. Consequently, more useful route guide information can be distributed to the user of the terminal.

(Example Modification of the Third Embodiment)

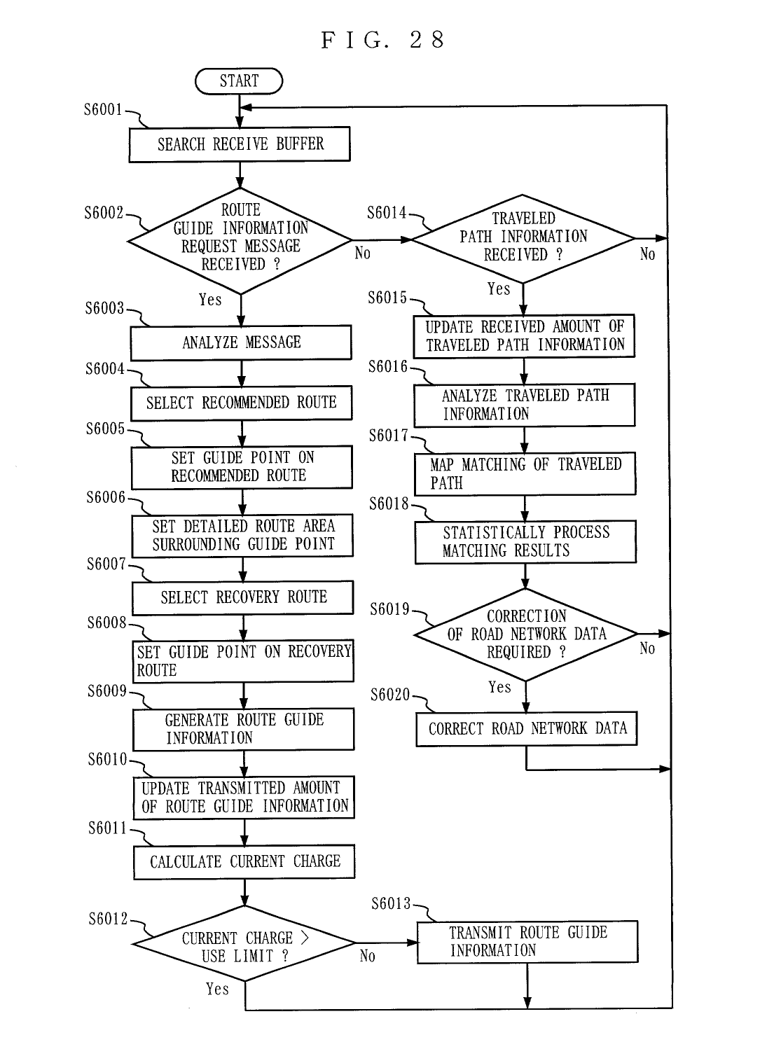

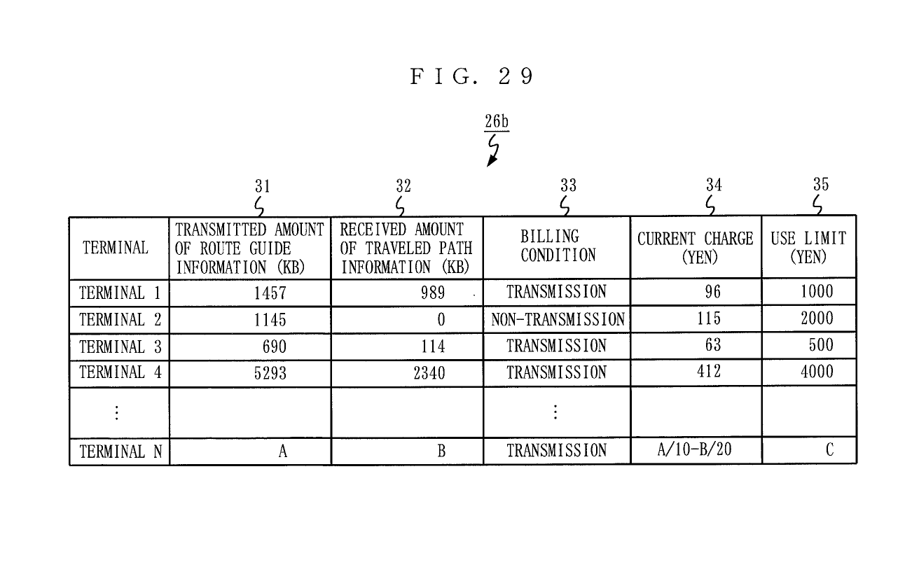

In the system according to the third embodiment, the center station 4 carries out the fee calculating process shown in FIG. 27 at regular intervals. Alternatively, the fee may be calculated every time the route guide information is transmitted, as described below. FIG. 28 is a flowchart showing the main processing in the center station 4 according to an example modification of the third embodiment of the present invention. FIG. 29 is an illustration showing an example of a billing management table 26 according to the example modification. The flowchart shown in FIG. 28 is similar to the flowchart shown in FIG. 25, provided with a process for calculating a current charge (step S6011) and a process for determining whether to transmit the route guide information (step S6012). The steps other than steps S6011 and S6012 are the same as those in the third embodiment, and therefore not described herein.

A billing management table 26b shown in FIG. 29 is similar to the billing management table 26a, provided with a current charge 34 and a use limit 35. In FIG. 29, the current charge 34 indicates a fee currently charged to the terminal for distribution of the route guide information. The use limit 35 is the limit amount of money chargeable to the terminal for distribution of the route guide information. The use limit 35 may be stipulated in a contract between the user of the terminal 1 and the operation company, or may be appropriately defined by the operation company based on the credibility of the user. Alternatively, the use limit 35 may be set to the amount of money already paid by the user of the terminal 1.

As shown in FIG. 28, the center station 4 updates the transmitted amount of route guide information 31 in the billing management table 26b in step S6010, and then operates as follows. Based on the updated billing management table 26b, the center station 4 calculates a fee for distribution of the route guide information, and sets the calculated fee as the current charge 34 in the billing management table 26b (step S6011). At this time, the fee is calculated with the processes in steps S5002 to S5006 shown in FIG. 27.

The center station 4 then determines based on the billing management table 26b whether the current charge 34 exceeds the use limit 35 or not (step S6012). If the current charge 34 does not exceed the use limit 35, the center station 4 transmits the route guide information generated in step S6009 (step S6013). If the current charge 34 exceeds the use limit 35, on the other hand, the center station 4 does not transmit the generated route guide information, and then the procedure goes to step S6001.

As such, the center station 4 calculates a fee whenever transmitting the route guide information, and does not respond to the route guide information request message transmitted from the terminal 1 when the current charge 34 exceeds the use limit 35.

The center station 4 according to the third embodiment has the following features:

(1) distributes, in response to the route guide information request message, route guide information including data varying in degree of details depending on the distance from the guide point;

(2) corrects the road network data based on the traveled path information received from the terminal; and

(3) applies, for distribution of the route guide information, either one of the two different fee schedules to the terminal depending on whether the terminal allows transmission of the traveled path information or not.

As evident from the above description, even the center station 4 having only the features (2) and (3) may have a better chance to collect more traveled path information and further improve the accuracy of the map data. Thus, more useful route guide information can be distributed to the user of the terminal.

While the invention has been described in detail, the foregoing description is in all aspects illustrative and not restrictive. It is understood that numerous other modifications and variations can be devised without departing from the scope of the invention.

What is claimed is:

1. A route guide information distributing apparatus for distributing route guide information to a terminal, the apparatus comprising:
communications means for transmitting and receiving data from and to the terminal;
map data storage means for storing map data;
route searching means for searching, by using the map data stored in the map data storage means, for a recommended route between arbitrary points requested by the terminal;
guide point setting means for setting a guide point on the recommended route found by the route searching means; and
route guide information generating means for generating the route guide information related to the recommended route for distribution to the terminal based on the map data stored in the map data storage means, the route guide information including data varying in degree of details depending on a distance from the guide point.

2. The route guide information distributing apparatus according to claim 1, wherein
the data included in the route guide information is more detailed as the distance from the guide point is shorter.

3. The route guide information distributing apparatus according to claim 2, wherein
the data of an area within a predetermined distance away from the guide point included in the guide information has at least road names, road shapes, a direction of travel at the guide point, and a recovery route for getting a vehicle back to the recommended route, and
the data of an area the predetermined distance or more away from the guide point has at least road names and a direction of travel at the guide point.

4. The route guide information distributing apparatus according to claim 1, wherein
the guide point setting means sets the guide point on the recommended route at a point where a road name is changed.

5. The route guide information distributing apparatus according to claim 1, wherein
the guide point setting means sets the guide point on the recommended route at a point where a direction of travel is changed more than a predetermined angle.

6. The route guide information distributing apparatus according to claim 1, further comprising
guide program generating means for generating a route guide program to be executed in route guidance carried out by using the route guide information, the program being distributed to the terminal.

7. The route guide information distributing apparatus according to claim 1, further comprising
map data updating means for updating the map data stored in the map data storage means based on traveled path information received from the terminal.

8. The route guide information distributing apparatus according to claim 7, wherein
the map data updating means carries out a statistical process on the traveled path information for obtaining statistical data, and updates the map data stored in the map data storage means based on the obtained statistical data.

9. The route guide information distributing apparatus according to claim 8, wherein
the route searching means searches for the recommended route between the arbitrary points by using the map data stored in the map data storage means and the statistical data obtained by the map data updating means.

10. The route guide information distributing apparatus according to claim 7, further comprising
billing managing means for carrying out a billing process for distribution of the route guide information by applying different schemes to the terminal depending on whether the terminal allows transmission of the traveled path information or not.

11. A route guide information distributing apparatus for distributing route guide information to a terminal, the apparatus comprising:
communications means for transmitting and receiving data from and to the terminal;
map data storage means for storing map data;
route searching means for searching, by using the map data stored in the map data storage means, for a recommended route between arbitrary points requested by the terminal;
route guide information generating means for generating the route guide information related to the recommended route for distribution to the terminal based on the map data stored in the map data storage means;
map data updating means for updating the map data stored in the map data storage means based on traveled path information received from the terminal; and
billing managing means for carrying out a billing process for distribution of the route guide information by applying different schemes to the terminal depending on whether the terminal allows transmission of the traveled path information or not.

12. The route guide information distributing apparatus according to claim 11, wherein
the map data updating means carries out a statistical process on the traveled path information for obtaining statistical data, and updates the map data stored in the map data storage means based on the obtained statistical data.

13. The route guide information distributing apparatus according to claim 12, wherein
the route searching means searches for the recommended route between the arbitrary points by using the map data stored in the map data storage means and the statistical data obtained by the map data updating means.

14. A route guide information receiving apparatus for carrying out route guidance by using route guide information distributed by a server, the route guide information receiving apparatus comprising:
position detecting means for detecting a current position of the apparatus by using a sensor;
communications means for transmitting and receiving data from and to the server;
route guide information receiving means for requesting the server to distribute the route guide information related to a recommended route between arbitrary points, the route guide information including data varying in degree of details depending on a distance from a guide point set on the recommended route; and
route guiding means for carrying out the route guidance by using the route guide information received by the route guide information receiving means and the current position detected by the position detecting means.

15. The route guide information receiving apparatus according to claim 14, wherein
the data included in the route guide information is more detailed as the distance from the guide point is shorter.

16. The route guide information receiving apparatus according to claim 15, wherein
the data of an area within a predetermined distance away from the guide point included in the guide information has at least road names, road shapes, a direction of travel at the guide point, and a recovery route for getting a vehicle back to the recommended route, and
the data of an area the predetermined distance or more away from the guide point has at least road names and a direction of travel at the guide point.

17. The route guide information receiving apparatus according to claim 14, wherein
the guide point is set on the recommended route at a point where the road name is changed.

18. The route guide information receiving apparatus according to claim 14, wherein
the guide point is set on the recommended route at a point where a direction of travel is changed more than a predetermined angle.

19. The route guide information receiving apparatus according to claim 14, wherein
the route guiding means carries out the route guidance by following a route guide program distributed by the server.

20. The route guide information receiving apparatus according to claim 14, further comprising
traveled path information generating means for generating traveled path information based on the current position detected by the position detecting means.

21. The route guide information receiving apparatus according to claim 20, further comprising
transmission switching means for switching whether or not to transmit the traveled path information to the server depending on a selection by a user.

22. A route guide information receiving apparatus for carrying out route guidance by using route guide information distributed by a server, the route guide information receiving apparatus comprising:
position detecting means for detecting a current position of the apparatus by using a sensor;
communications means for transmitting and receiving data to and from the server;
route guide information receiving means for requesting the server to distribute the route guide information related to a recommended route between arbitrary points;
route guiding means for carrying out the route guidance by using the route guide information received by the route guide information receiving means and the current position detected by the position detecting means;
traveled path information generating means for generating traveled path information for transmission to the server based on the current position detected by the position detection means; and
transmission switching means for switching whether or not to transmit the traveled path information to the server depending on a selection by a user.
